(19) United States
(12) Patent Application Publication
(10) Pub. No.: US 2026/0219387 A1
(43) Pub. Date: Jul. 30, 2026

(54) METHODS, SYSTEMS, AND COMPUTER READABLE MEDIA FOR PROVIDING 3D IMAGING USING RADIO FREQUENCIES

(71) Applicant: The Trustees of the University of Pennsylvania, Philadelphia, PA (US)

(72) Inventors: Mingmin Zhao, Bala Cynwyd, PA (US); Gaoxiang Luo, Philadelphia, PA (US); Yifei Liu, Philadelphia, PA (US); Haowen Lai, Philadelphia, PA (US)

(21) Appl. No.: 19/464,552

(22) Filed: Jan. 29, 2026

Related U.S. Application Data
(60) Provisional application No. 63/751,820, filed on Jan. 30, 2025.

(51) Int. Cl. G01S 13/90; G06T 3/4046; G06V 10/82; G06V 20/64

(52) U.S. Cl. CPC G01S 13/9082; G01S 13/9021; G06T 3/4046; G06V 10/82; G06V 20/64; G06T 2200/04

(57) ABSTRACT

A system for providing three-dimensional (3D) imaging using radio frequencies (RFs) includes a millimeter-wave (mmWave) radar chip on a mobile robot comprising antennas, the mmWave radar chip configured for rotating to emulate a cylindrical array of antennas. The system further includes an RF imaging system that receives, by the rotating antennas, RF signals, estimates locations of the rotating antennas when the RF signals were received, processes the RF signals received by the antennas using the estimated locations of the antennas to provide 3D imaging; and enhances resolution of the 3D imaging using machine learning.

### PRIORITY CLAIM

This application claims the priority benefit of U.S. Provisional Patent Application Ser. No. 63/751,820, filed Jan. 30, 2025, the disclosure of which is incorporated herein by reference in its entirety.

### TECHNICAL FIELD

The subject matter described herein relates to three-dimensional (3D) imaging of objects. Mor particularly, the subject matter described herein relates to high resolution 3D imaging of objects using radio frequency (RF) signals.

### BACKGROUND

The emergence of robotic and autonomous systems in areas such as transportation, search and rescue, construction, healthcare assistance, and warehouse management are poised to improve efficiency, safety, and human well-being across a diverse range of sectors. To ensure accurate and robust perception of the surroundings, RF signals-based sensing and imaging have appeared as promising techniques. These RF systems offer distinct advantages over traditional optical sensors, with resilience against environmental challenges such as dust, fog, smoke, and adverse lighting conditions.

The fundamental limitation of RF sensors compared to optical sensors, however, lies in their poor resolution. Unlike cameras, where millions of pixels can be integrated into a CMOS sensor, RF sensors typically consist of significantly fewer antennas. This constraint results in limited angular resolution, causing objects in close proximity to appear smeared or indistinct. Such limitations have led to substantial challenges in capturing high-resolution RF images that convey object and environment details.

Past research has explored different methods to enhance the resolution of RF images. Some techniques focus on specific categories such as humans or vehicles, leveraging category-specific prior knowledge or generative models. Other solutions employ synthetic aperture radar techniques by moving radars on slide rails; however, this method is unsuitable for mobile robots due to the cumbersome rail sizes (e.g., 1.2 m) and slow scanning speed (e.g., 5 mins). Additionally, researchers have sought to improve resolution by opportunistically leveraging the external motion from a robot. This approach, however, can only enhance resolution in the moving direction and becomes ineffective when the robot is static. There is a need for high-resolution RF three-dimensional (3D) imaging systems on mobile robots that are economical.

### SUMMARY

Methods, systems, and computer readable media for providing 3D imaging using radio frequencies are disclosed. An example method for providing three-dimensional (3D) imaging using radio frequencies (RFs) includes rotating a millimeter-wave (mmWave) radar chip including antennas on a mobile robot to emulate a cylindrical array of antennas. The method further includes receiving, by the rotating antennas, RF signals. The method further includes estimating locations of the rotating antennas when the RF signals were received. The method further includes processing the RF signals received by the antennas using the estimated locations of the antennas to provide 3D imaging. The method further includes enhancing resolution of the 3D imaging using machine learning.

According to another aspect of the method described herein, enhancing resolution of the 3D imaging using machine learning includes interpolating vertical imaging using the processed RF signals and machine learning.

According to another aspect of the method described herein, enhancing resolution of the 3D imaging using machine learning further includes compressing RF signals along a range dimension using two-dimensional (2D) Convolutional Neural Networks (CNNs).

According to another aspect of the method described herein, estimating locations of the rotating antennas when the radio frequency signals were received includes determining a motion of the robot.

According to another aspect of the method described herein, the locations of the antennas are estimated to a subwavelength location accuracy.

According to another aspect of the subject matter described herein, the method includes recognizing objects in the 3D imaging.

According to another aspect of the method described herein, enhancing resolution of the 3D imaging includes detecting transparent glass.

According to another aspect of the method described herein, the machine learning includes a model trained with RF data and LiDAR data of targets.

An example system for providing three-dimensional (3D) imaging using radio frequencies (RFs) includes a millimeter-wave (mmWave) radar chip on a mobile robot including antennas, the mmWave radar chip configured for rotating to emulate a cylindrical array of antennas. The system further includes an RF imaging system configured for receiving, by the rotating antennas, RF signals. The RF imaging system is further configured for estimating locations of the rotating antennas when the RF signals were received. The RF imaging system is further configured for processing the RF signals received by the antennas using the estimated locations of the antennas to provide 3D imaging. The RF imaging system is further configured for enhancing resolution of the 3D imaging using machine learning.

According to another aspect of the system described herein, the RF imaging system is configured for interpolating vertical imaging using the processed RF signals and machine learning.

According to another aspect of the system described herein, the RF imaging system is configured for compressing RF signals along a range dimension using two-dimensional (2D) Convolutional Neural Networks (CNNs).

According to another aspect of the system described herein, the RF imaging system estimates locations of the rotating antennas when the radio frequency signals were received by determining a motion of the robot.

According to another aspect of the system described herein, the locations of the antennas are estimated to a subwavelength location accuracy.

According to another aspect of the system described herein, the RF imaging system is configured for recognizing objects in the 3D imaging.

According to another aspect of the system described herein, the RF imaging system is configured for detecting transparent glass.

According to another aspect of the system described herein, the machine learning includes a model trained with RF data and LiDAR data of targets.

An example non-transitory computer readable medium has stored thereon executable instructions that when executed by at least one processor of at least one computer cause the at least one computer to perform steps including receiving, by rotating antennas of a millimeter-wave (mmWave) radar chip on a mobile robot, RF signals. The steps further include estimating locations of the rotating antennas when the RF signals were received. The steps further include processing the RF signals received by the antennas using the estimated locations of the antennas to provide 3D imaging. The steps further include enhancing resolution of the 3D imaging using machine learning.

According to another aspect of the non-transitory computer readable medium described herein, enhancing resolution of the 3D imaging using machine learning includes interpolating vertical imaging using the processed RF signals and machine learning.

According to another aspect of the non-transitory computer readable medium described herein, enhancing resolution of the 3D imaging using machine learning further includes compressing RF signals along a range dimension using two-dimensional (2D) Convolutional Neural Networks (CNNs).

According to another aspect of the non-transitory computer readable medium described herein, estimating locations of the rotating antennas when the radio frequency signals were detected includes determining a motion of the robot.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter described herein will now be explained with reference to the accompanying drawings of which:

FIGS. 1A-1G show RF imaging and visual recognition with PanoRadar. FIGS. 1A-1G illustrate the capabilities of the system, showing, in FIG. 1A, the 3D panoramic LiDAR range image as a reference, and, in FIG. 1B, the RF-based prediction generated by our system. Our LiDAR-comparable results enable a variety of visual recognition tasks, including, as shown in FIG. 1C, surface normal estimation, as shown in FIG. 1D, semantic segmentation, and, as shown in FIG. 1E object detection and human localization. Additionally, we present in FIG. 1F the LiDAR 3D point cloud color-coded with manually-annotated semantic labels, and, in FIG. 1G, the predicted RF-based point cloud color-coded by the corresponding predicted semantic categories, which offers an enriched understanding of the 3D surroundings;

FIG. 2 shows (left) a schematic of the PanoRadar system rotating a single-chip mmWave radar using a motor, with its linear antenna array placed vertically and (right) a schematic of a dense cylindrical array of antennas emulated by the rotation;

FIG. 3 is a block diagram showing the PanoRadar architecture with four components: a 3D imaging system for cylindrical arrays (§ 4), a motion estimation and compensation algorithm (§ 5), a resolution enhancement and range image estimation model (§ 6.1), and visual recognition heads for downstream tasks (§ 6.2);

FIG. 4 shows RF imaging results with a stationary robot. Our 3D imaging method can capture the humans in a rough shape, but the elevation resolution still needs enhancement;

FIGS. 5A-5D show distortion of the imaging results due to robot motion. 2D visualizations show that the distortion gets worse as the robot starts to move. FIG. 5A shows a 2D image captured by LiDAR when the robot is static, FIG. 5B shows a 2D image captured by radar when the robot is static, FIGS. 5C and 5D show 2D images captured by radar when a robot begins to accelerate;

FIGS. 6A and 6B include RF spectrograms showing reflections from an object in a spectrogram (FIG. 6A) and compensated spectrogram (FIG. 6B); and

FIGS. 7A-7C are diagrams illustrating robust motion estimation with multiple observations. First, we use range FFT to isolate reflectors at different ranges FIG. 7A shows diagrams of compensated spectrograms at different range bins, FIG. 7B shows diagrams with detected lines and peaks from the compensated spectrograms, and FIG. 7C shows diagrams of sinusoidal curves fitting to estimate a speed and heading direction;

FIG. 8 shows RF imaging results with a moving robot with beamforming (top) and with additional ML-based resolution enhancement (mid). Our motion estimation and compensation avoid the distortion, resulting in high range and azimuth resolutions. The 3D learning model further enhances the elevation resolution, showing detailed structures like stairs;

FIG. 9 shows RF image resolution enhancement illustrating PanoRadar learning the first reflection under the presence of multipath interference;

FIG. 10 shows RF image resolution enhancement illustrating PanoRadar detecting glass regions and recovers its depth while LiDAR fails to do so;

FIG. 11 shows range images with fine-grained details produced by PanoRadar;

FIG. 12 shows a 2D floor map wherein PanoRadar localizes humans;

FIG. 13 shows PanoRadar detecting objects across an image boundary;

FIG. 14A is a top view image of the PanoRadar and FIG. 14B is a side view of the PanoRadar;

FIG. 15 show RF image resolution enhancements illustrating PanoRadar performance on diverse building environments. For every two rows, the top is PanoRadar's prediction and the bottom is the ground truth;

FIG. 16 is a graph of the CDF for absolute error of range image estimation;

FIG. 17 is a graph of the effect of motion errors on imaging performances;

FIG. 18 includes graphs showing the error of motion estimation across 12 buildings;

FIG. 19 illustrates graphs of performance of visual recognition at different distances: short (0-3 m), mid (3-6 m) and long (6-10 m);

FIG. 20 includes graphs showing the column-wise metrics of circular and non-circular model across 512 azimuth columns for range estimation, surface normal estimation, and semantic segmentation;

FIG. 21 is a graph of the AP³⁰ verses split percentile in panoramic-rotate test;

FIG. 22 includes graphs of (left) simulated response E(θp) with different FOV window sizes and (right) simulation and experiment results for angular resolution; and

FIG. 23 is a flow chart of an example method for providing 3D imaging using radio frequencies.

### DETAILED DESCRIPTION

The subject matter described herein includes methods, systems, and computer readable media for providing 3D imaging using radio frequencies, referred to herein as PanoRadar. PanoRadar includes a mmWave radar chip on a mobile robot. The chip includes one or more antennas, such as four, eight, twelve, sixteen, or any other number of antennas known within the field for single-chip mmWave radar. The chip is configured for rotating on the robot to emulate a cylindrical array of antennas. Using radio frequencies, PanoRadar is able to provide imaging through dust, fog, walls, and the like.

PanoRadar includes an RF imaging system configured for receiving RF signals by the rotating antennas. PanoRadar provides 3D imaging by processing RF signals and then enhancing resolution of the imaging with machine learning. PanoRadar estimates locations of the rotating antennas when the RF signals were received, which can be within a wavelength location accuracy. PanoRadar can estimate the location of the rotating antennas by determining the motion of the robot and the rotational location of the antennas on the robot, which requires determining the Doppler effect and angle of arrival of the signals upon the antennas. PanoRadar processes the RF signals received by the antennas using the estimated locations of the antennas to provide 3D imaging and then enhances the resolution of the 3D imaging using machine learning. The machine learning can be used to enhance vertical imaging by extrapolating imaging vertically with ground truths such as smooth surfaces and gravity constraints requiring objects to have vertical support.

PanoRadar is an RF imaging system that brings RF resolution close to that of LiDAR, while providing resilience against conditions that are challenging for optical signals. LiDAR-comparable 3D imaging results enable, for the first time, a variety of visual recognition tasks at radio frequency, including surface normal estimation, semantic segmentation, and object detection. PanoRadar utilizes a rotating single-chip millimeter-wave (mmWave) radar, along with a combination of novel signal processing and machine learning algorithms, to create high-resolution 3D images of the surroundings. The system accurately estimates robot motion, allowing for coherent imaging through a dense grid of synthetic antennas. It also exploits the high azimuth resolution to enhance elevation resolution using learning-based methods. Furthermore, PanoRadar tackles 3D learning via 2D convolutions and specifically addresses challenges due to the unique characteristics of RF signals.

### 1. INTRODUCTION

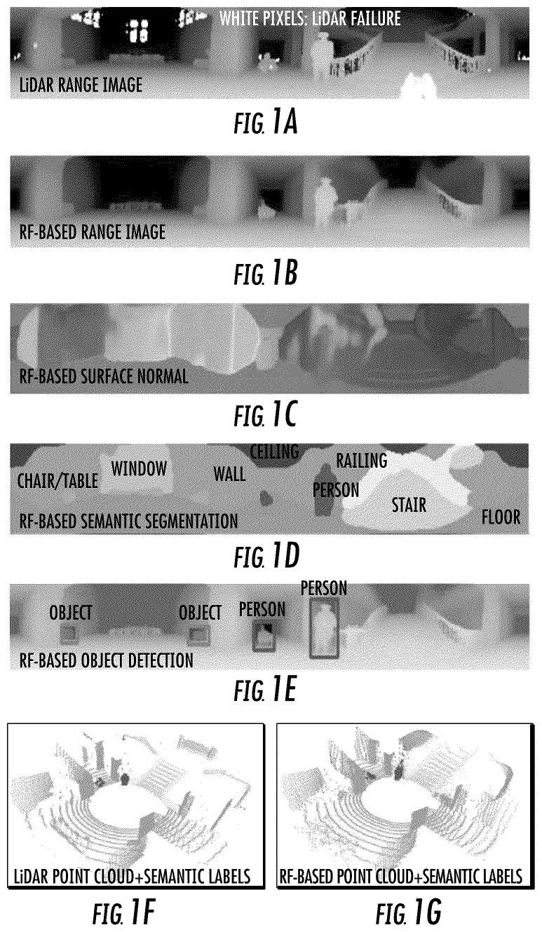

PanoRadar is an RF imaging system that enhances sensing resolution to a level similar to LiDAR, enabling a wide array of visual recognition tasks with RF signals. PanoRadar operates by rotating a single-chip mmWave radar with a motor, forming a dense cylindrical array of antennas. Our system then utilizes a combination of novel signal processing and machine learning algorithms to create high-resolution 3D images of the surroundings. FIGS. 1A-1G show an example output from our system and compare it with a panoramic 3D LiDAR (Ouster OSO-64, 64-beam, ~$9000 USD). FIG. 1A presents the range image captured by the LiDAR, while FIG. 1B showcases PanoRadar's output based solely on RF signals. Our predictions offer a resolution comparable to 3D LiDAR, capturing detailed structures of a building, including walls, floors, ceilings, stairs, as well as humans and objects (e.g., chairs, bench). Equipped with this LiDAR-comparable range image, PanoRadar enables visual recognition tasks with RF signals, such as surface normal estimation, semantic segmentation, and object and human detection (FIGS. 1C-1E). Outputs from PanoRadar can be viewed in 3D (FIG. 1G), with predicted 3D point clouds color-coded by semantic predictions, offering an enhanced visualization and understanding of the surroundings. FIG. 1F provides a reference captured by LiDAR with manual annotations.

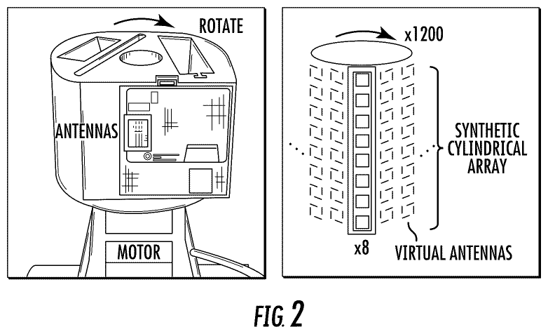

A key design of PanoRadar involves the rotation of a mmWave radar. As illustrated in FIG. 2, our system employs a commercial off-the-shelf (COTS) single-chip mmWave radar and rotates it around the vertical axis using a motor. Since the linear array is placed vertically, this rotation forms a dense cylindrical array of synthetic antennas (8×1200). This unique design offers several distinct benefits: 1) The rotation around the vertical axis greatly enhances the azimuth resolution to 2.6 degrees (§ 4). 2) By vertically placing the linear array, our system can perform beamforming along the vertical axes, enabling 3D imaging of the environment. 3) The rotation also expands the otherwise static limited field of view (FOV), typically ranging from 30-60 degrees, providing panoramic sensing of the environment. 4) With COTS radar and motor and a compact rotation radius of 8 cm, the system ensures low cost, fast capture time and enhanced mobility. Our design stands apart from existing mechanical radars, which rotate costly and customized directional antennas and are limited to 2D mapping.

Despite the above benefits, designing and implementing PanoRadar presents multiple challenges. The first one is the external motion during sensor rotation (e.g., the sensor on a moving robot). Coherent combination of all the synthetic antennas requires their precise location at a sub-wavelength level (e.g., λ/2=1.9 mm at 79 GHz).

Unfortunately, commonly used sensors like IMUs or wheel odometers cannot track robot motion with such accuracy. Ideally, we would leverage reflected RF signals from the environment for motion estimation (e.g., the Doppler effect). However, this is difficult as the Doppler effect measures the radial speed along the direction of the reflector, and without knowing the exact angle of arrival (AoA) of reflectors, we cannot recover the velocity (i.e., speed and heading direction). What is worse, AoA and Doppler effect are intertwined, as they both manifest as the frequency shift across multiple antenna measurements. To overcome these challenges, we design novel signal processing algorithms to untangle this ambiguity between AoA and Doppler effect. Our algorithm tracks reflections from the same reflector during radar rotation and leverages the directional characteristic of mmWave antennas to identify its AoA (i.e., the same reflector would have the strongest reflection when the reflector is oriented at 90 degrees with respect to the radar). By incorporating multiple reflectors from the environment and observing radial speed from different angles, PanoRadar achieves robust motion estimation and compensation.

The second challenge pertains to the limited elevation resolution. While our system achieves high resolution along the azimuth (1200 virtual antennas) and range (3.75 cm with 4 GHz bandwidth) dimensions, its elevation resolution is limited due to significantly fewer antennas along the vertical axis (8 for the COTS radar used). To overcome this, we leverage the high azimuth and range resolution to enhance the elevation resolution. While direct information transfer between these dimensions is generally impractical, it becomes feasible in our case due to the inherent low-rank structures and unique attributes of indoor environments. For example, common indoor structures like walls, floors, ceilings, stairs, and furniture introduce regularities in range images, and consistent depth cues from these surfaces can be used to infer information vertically. Similarly, gravity constraints—such as how humans and objects need support and stand on the floor—can be utilized in a similar manner. We employ learning-based methods to capitalize on these insights, i.e., models trained with a large dataset of paired LiDAR and RF data to enhance elevation resolution for RF inputs. By recognizing and utilizing consistent patterns in indoor scenes, our model allows for more accurate predictions and a richer understanding of the 3D environment.

Finally, the design of machine-learning (ML) models for high-resolution RF imaging and the subsequent visual recognition tasks presents a set of challenges due to the unique characteristics of RF signals and the complexity of learning with 3D panoramic data. At the forefront of these challenges is 3D learning. While 3D convolution might seem an intuitive choice for learning the 3D structure from our 3D RF data, it rapidly becomes impractical. Consider voxelizing a space of 20 m×20 m×5 m with 2 cm cubes; the resulting tensor size of 1000×1000×250, not even accounting for the channel dimension, would require excessive processing and memory with 3D CNN. This is compounded by the challenge of learning from highly-imbalanced occupancy grids (i.e., less than 1% of the voxels would be filled). Our approach utilizes 2D models to facilitate 3D learning by taking advantage of the intrinsic sparsity in both LiDAR and RF data. First, we repurpose the range dimension as channels and feed the 3D RF data into 2D models. Unlike conventional CNNs, we begin our models with a 4× reduction in the channel dimension, optimizing for efficiency given the sparse RF reflections along the range dimension. Second, our model is designed to predict a 2D range image that indicates the distance to the first reflector from various directions, essentially converting it into a 2D prediction task. In addition to this challenge, our design also tackles other issues such as: 1) the inability of LiDAR to capture glass and the resulting incorrect range supervision for RF inputs during training; 2) multi-path reflections in RF signals, which could result in ghost objects; and 3) the need for our model to harness to the panoramic nature of RF imagery.

We build a prototype of PanoRadar and deploy it on mobile robots, together with a 3D LiDAR for reference. We also annotate LiDAR points with semantic and object labels as ground truth for the corresponding recognition tasks. We conduct experiments in 12 different buildings around our campus and run leave-one-building-out training/testing splits to ensure generalization across buildings. For motion estimation, PanoRadar's mean speed error is 8.48 mm/s, and the mean heading direction error is 1.09°. For 3D imaging, the mean error of our range prediction is 15.76 cm. PanoRadar achieves an 8.83° surface normal estimation error, a mean intersection over union (mloU) of 48.00 for semantic segmentation, and an average precision (AP³⁰) of 52.34% for object detection.

The key contributions of the described subject matter and example test setups described herein include the following:
We introduce the first RF imaging system that achieves resolution close to that of LiDAR. It enables, for the first time, visual recognition with RF, including surface normal estimation, semantic segmentation, and object detection.
We present a novel design that integrates a COTS mmWave radar with a motor to significantly enhance sensing resolution and FoV, while ensuring that the system remains compact, low-cost, and practical for mobile robots.
We propose a novel robot motion estimation algorithm that accurately estimates and compensates for robot motion, allowing for coherent combination of radar signals.
We introduce a learning model that effectively enhances vertical resolution using high azimuth and range resolutions, while maintaining efficiency with 2D convolutions.
We evaluate our system across 12 diverse buildings, demonstrating its feasibility, accuracy, and robustness in various environments.

### 2. RELATED WORK

RF Imaging and Sensing: Recent years have witnessed an increasing interest in wireless and RF imaging. Various techniques have been explored including WiFi, RFID, radars, and combinations of multiple sensors to perceive and image the object. Synthetic aperture radar (SAR) is a common technique used to enhance imaging resolution. Previous work uses horizontal and vertical sliders to move the radar, emulating a planar array. However, this method is limited by its long scanning time (e.g., 5 minutes in) and cumbersome setup. Circular SAR has also been explored with enhanced efficiency and panoramic sensing capability. Despite its improvements, it has mainly been adopted in large static setups, such as security scanners and CT scanners, as coherent imaging is challenging in the presence of motion. There is also previous work that utilizes 360-degree radars for autonomous vehicles. These systems use mechanical radars such as Navtech CTS350-X, which forms a narrow beam with expensive radars and can only provide 2D mapping of the surroundings. Machine learning is another avenue to enhance resolution and image quality. 2D CNNs have been used to enhance 2D RF imaging in either range-azimuth format or Cartesian format. Similarly, 3D convolution has also been used for 3D imaging. Although intuitive, 3D convolution is computationally heavy and prone to over-fitting when learning sparse structures. Additionally, learning-based imaging and sensing have primarily focused on humans and vehicles. For example, learning-based human sensing includes pose estimation, body mesh reconstruction, action recognition, etc., while learning-based vehicle perception emphasizes detection and reconstruction. However, focusing on specific classes might overlook other categories that are equally important in various contexts. Furthermore, the sensing algorithm might integrate category-specific priors (e.g., background subtraction which targets moving humans by eliminating static reflections), limiting its applicability as a general imaging solution.

Computer vision: Significant efforts have driven substantial advancements in the field of visual recognition based on cameras and LiDAR, as well as their fusion. Cameras excel at capturing high-resolution spatial information in the form of images, yet they rely heavily on adequate lighting for imaging, rendering them unusable in low-light or harsh weather conditions.

Meanwhile, LiDAR sensors utilize lasers to capture environmental geometry, producing 3D point clouds. However, they are susceptible to airborne particles like smoke and dust, and 3D LiDAR systems are expensive.

### 3. OVERVIEW

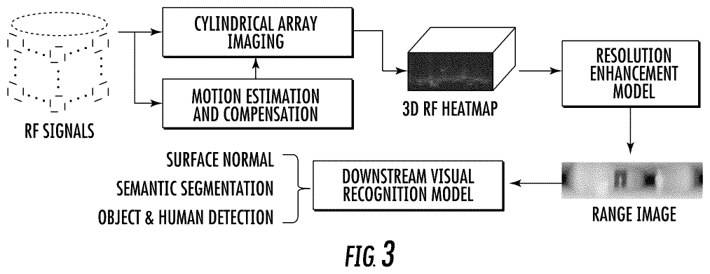

PanoRadar is an RF imaging system that delivers LiDAR-comparable resolution and enables visual recognition. FIG. 3 illustrates the system architecture of PanoRadar, consisting of four components: 1) 3D imaging with a rotating radar: we describe cylindrical array imaging and analyze imaging resolution (§ 4); 2) Motion estimation and compensation: we present our novel algorithms for accurate estimation of robot motion, and efficient imaging algorithms with compensation (§ 5); 3) Vertical resolution enhancement and range image estimation: we detail our design of ML methods that efficiently learn 3D structures with 2D models (§ 6.1); and 4) Visual recognition heads: we outline our design of models for various downstream recognition tasks (§ 6.2).

### 4. CYLINDRICAL ARRAY IMAGING

We begin with the fundamentals of RF imaging using a rotating radar. In this section, we focus on a specific scenario in which the robot platform remains stationary, i.e., the only movement experienced by the radar is the motor-driven rotation. Recall from FIG. 2 that our system employs a unique design that uses rotation to create a synthetic cylindrical array. Specifically, assuming our system has A antennas placed vertically, each with a height of h^{a}=1, . . . , A, and the antennas are rotating with radius r and angular speed ω, the location of antenna a at time t can be expressed as:

$${\vec{p}}_{t}^{a} = ( r cos ( ω t ) , r sin ( ω t ) , {h}^{a} ) . \qquad ( 1 )$$

Given a cylindrical array, consider an imaging direction of interest \vec{d} with azimuth σ_{d} and elevation angle φ_{d}:

$$\vec{d} = ( cos {∅}_{d} cos {θ}_{d} , cos {∅}_{d} sin {θ}_{d} , sin {∅}_{d} ) . \qquad ( 2 )$$

The key to forming a narrow beam along d̅ is to coherently combine all the antennas by compensating for their difference in the distance to the plane perpendicular to d̅. Since this distance can be denoted as the dot product of \vec{d} and

$${\vec{p}}_{t}^{a} ,$$

our 2D beamforming can be achieved via:

$$B ( \vec{d} ) = {\sum }_{a , t} {S}_{t}^{a} exp ( j 4 π \frac{\vec{d} \cdot {\vec{p}}_{t}^{a}}{λ} ) , \qquad ( 3 )$$

where

$${S}_{t}^{a}$$

represents the intermediate frequency (IF) signals from antenna a at time t and B(d̅) is the beam formed. We perform range FFT on B(\vec{d}) to obtain the range dimension, indicating the distance of reflectors along this direction. By querying beams along a 2D grid of azimuth and elevation angles, we obtain a 3D (i.e., azimuth×elevation×range of size 64×512×256) tensor showing reflections from the 3D surroundings. We note that since the mmWave radar antennas used here are not omni-directional (i.e., they have a 3-dB beamwidth of around 30° along the azimuth dimension), we limit the antenna positions used for summation in (3) to those centered around θ_{d} for efficiency purposes.

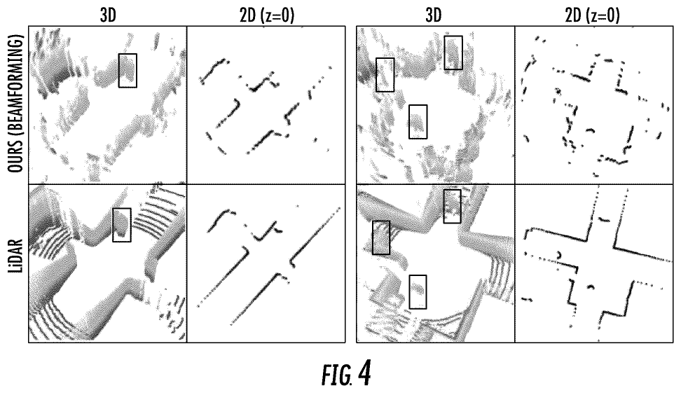

FIG. 4 shows a few examples of our 3D imaging outputs using beamforming, together with the reference point clouds captured by a 3D LiDAR. We also visualize a 2D slice (i.e., z=0) of the point clouds which resemble 2D mapping results (i.e., floor plans). It can be observed that our beamforming-based imaging results achieve fine-grained azimuth resolution with a large synthetic aperture and fine-grained range resolution with a large bandwidth at mmWave frequency. However, the elevation resolution remains limited due to a small number of vertical antennas. As a result, beamforming-based 3D images seem over-smoothed and fail to capture the detailed changes along the elevation dimension.

Below we analyze the imaging resolution of our beamforming algorithm, including the first analytical expression for azimuth resolution in circular/cylindrical arrays.

Elevation Resolution. Our design has a linear array along the vertical axis, consisting of A antennas with a spacing of λ/2. This configuration results in an elevation resolution of (determined by the 3-dB beamwidth of the imaging main-lobe): Δθ=0.892λ/L=1.98/A, where L is the aperture size and the unit of Δθ is in radians. For the specific radar we use with A=8 and λ=3.8 mm, our Δθ is 0.25 rad or 14.2°.

Range Resolution. The range resolution of FMCM radar is determined by its bandwidth B as: ΔR=c/2B, where c is the speed of light. For our radar configuration with B=4 GHz, our ΔR is 3.75 cm.

Azimuth Resolution. Our system effectively employs a circular array for resolving reflections along the azimuth dimension. We provide analytic expression for the beam shape and angular resolution when imaging with a circular array. To the best of our knowledge, this is the first set of analytic results for circular arrays. The proof of this lemma follows a similar approach to that of linear arrays, with the detailed derivation deferred to the Appendix.

### 4.1 Lemma

Consider a circular array of radius r and a reflector at angle θ=0, due to resolution, this reflector influences the imaging of nearby angle θₛ, with voltage E(θₛ) as:

$$E ( {θ}_{s} ) ∝ 2 π {J}_{0} ( \frac{4 π r}{λ} sin \frac{{θ}_{s}}{2} ) , \qquad ( 4 )$$

where J₀ denotes the Bessel function of the first kind. The 3-dB beamwidth of this beam is, therefore, the angular resolution of the circular array:

$$Δ θ = 0.36 \frac{λ}{r} = 0.72 \frac{λ}{d} , \qquad ( 5 )$$

where d=2r is the diameter of the circular array.

With a rotation radius of r=8 cm and a wavelength λ=3.8 mm, PanoRadar has an azimuth resolution Δθ=0.96⁰. We note that Lemma 4.1 assumes an omni-directional radiation pattern over either 180 or 360 degrees, the same as the analysis for linear arrays. Measurements of the azimuth resolution with actual radar radiation pattern, via both simulations and experiments, are presented in § 8.

### 5. MOTION ESTIMATION AND IMAGING

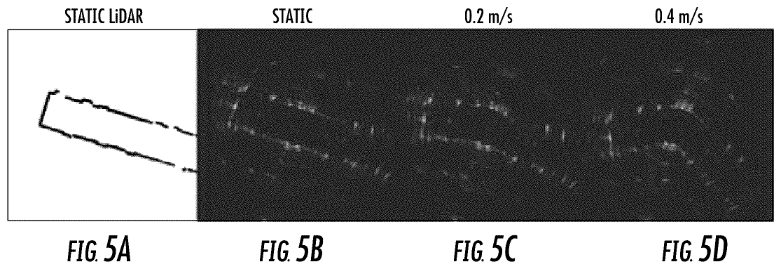

The external motion of the platform (e.g., a robot) can introduce unknown motion to the radar in addition to its own rotation. Obtaining antenna locations with sub-wavelength accuracy (i.e., λ/2=1.9 mm) is crucial for coherent combination and effective beamforming. FIGS. 5A-5D show how beamforming (Eqn. (3)) fails when external motion is not properly estimated and compensated. FIGS. 5A and 5B show that the 2D images captured by LiDAR and radar are similar when the robot is static. However, when the robot begins to accelerate and move forward (FIGS. 5C and 5D), the RF images become distorted, with objects appearing at incorrect locations.

To address this issue, we leverage the Doppler effect in the reflected signals to estimate robot motion. This task is, however, not trivial, as both the radar rotation and robot motion induce spatial frequency across antennas, leading to a mixed effect due to AoA and Doppler. Below, we describe how we decouple AoA and Doppler effect (§ 5.1), estimate robot motion (§ 5.2), and compensate for it efficiently (§ 5.3).

### 5.1 Angle of Arrival and Doppler Effect

We first model the net motion an antenna undergoes and how this affects its distance to a reflector. Assume the antenna rotates with radius r and angular velocity ω along the z-axis of the robot and has a linear velocity \vec{v} in the x,y-plane. We assume both ω and \vec{v} remain constant over one rotation cycle (i.e., 0.5 s). The origin of the coordinate system is set at the rotation center when t=0. We consider a reflector on the x,y-plane with the range Rn and azimuth θn. The distance between this reflector and the antenna at time t can be approximated (when Rn>>r, see Appendix) as:

$$d ( t ) = {R}_{n} - {\underbrace{r cos ( ω t - {θ}_{n} )}}_{radar rotation} - {\underbrace{vt cos ( {θ}_{v} - {θ}_{n} )}}_{robot motion} , \qquad ( 6 )$$

where v and θv are the speed and angle of \vec{v}. Notice that the second term in this equation accounts for radar rotation, while the third term results from the robot motion.

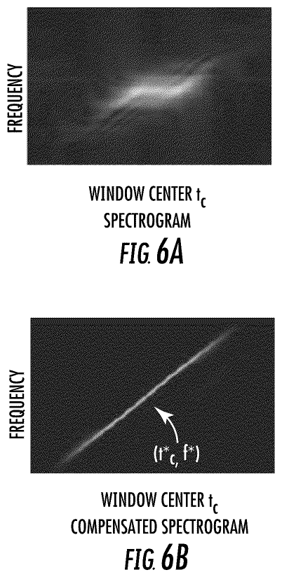

Performing FFT on antenna measurements over time (i.e., slow-time FFT) essentially analyzes the rate at which d(t) changes. As indicated in Eqn. (6), the slow-time FFT captures a combined effect of AoA and Doppler. Additionally, since d(t) does not vary at a constant rate (i.e., d(t) is not a linear function of t, the slow-time FFT has its energy spread out across spectrum. FIG. 6A shows the spectrogram obtained by applying FFT over a sliding window. The primary cause of the dispersion is the cosine nonlinearity introduced by the radar's rotation. To address this, our approach involves adding a compensation term to d(t) to linearize it in relation to t. Specifically, for each sliding window centered around t_{c}, we compensate for d(t) as follows:

$${d}^{′} ( t , {t}_{c} ) = d ( t ) + r cos ( ω ( {t}_{c} - t ) ) . \qquad ( 7 )$$

This compensation is achieved by multiplying the antenna measurements by exp{j4πr cos(ω(tc−t))/λ}. For ease of analysis, the compensated distance function d′(t, t_{c}) can be approximated (see Appendix) as:

$${d}^{′} ( t , {t}_{c} ) = r ω t ( ω {t}_{c} - {θ}_{n} ) - vt cos ( {θ}_{v} - {θ}_{n} ) + const . , \qquad ( 8 )$$

which is linear with respect to t. Thus, taking slow-time FFT over compensated antenna measurements would yield a strong response at frequency:

$$f ( {t}_{c} ) = \frac{2}{λ} [ r ω {\underbrace{( ω {t}_{c} - {θ}_{n} )}}_{AoA} - {\underbrace{v cos ( {θ}_{v} - {θ}_{n} )}}_{Doppler speed} ] , \qquad ( 9 )$$

where the first term reflects AoA (i.e., difference between radar direction and reflector direction) and the second term is the Doppler speed. FIG. 6B shows the spectrogram of the compensated signals, which exhibit sharp responses. Interestingly, it also shows that the f (t_{c}) is changing linearly over time, as dictated by Eqn. (9). Additionally, this line persists during the time window when the reflector is within the FoV of the rotating antenna. Moreover, due to the standard antenna radiation pattern, the strongest response appears when the antenna is directly facing the reflector. Specifically,

$$ω {t}_{c}^{*} = {θ}_{n} if ( {t}_{c}^{*} , {f}^{*} )$$

denotes the location of the strongest response on this line. Plugging it into Eqn. (9), we get the following equation regarding peak location:

$${f}^{*} = f ( {t}_{c}^{*} ) = - 2 v cos ( {θ}_{v} - ω {t}_{c}^{*} ) / λ . \qquad ( 10 )$$

Observe that by identifying this line and its peak, we can determine the AoA and Doppler effect separately. Specifically,

$$ω {t}_{c}^{*}$$

indicates the direction of the reflector, while −λf*/2 quantifies its Doppler speed. We use Hough transform for line detection in the compensated spectrogram. Since we know the slope for lines of interest (i.e., 2ω²r/λ), we speed up the detection by restricting the slope search to this value.

### 5.2 Robust Motion Estimation

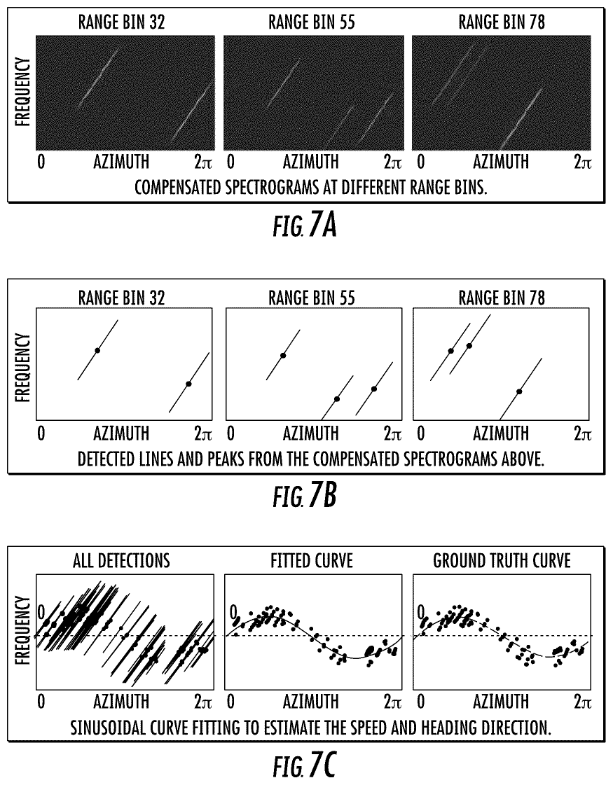

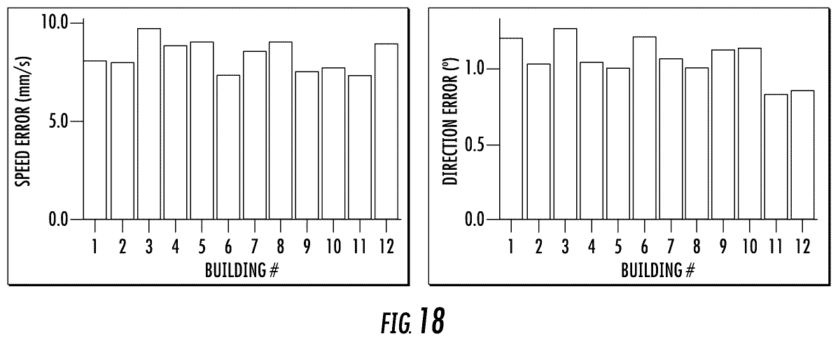

Measurement of AoA and Doppler speed from just a single reflector falls short in estimating both v and Ov. The Doppler speed, after all, only reveals the radial speed in the direction of the reflector. This is further complicated by the noise or errors in the detected lines and peaks. We tackle this challenge by using multiple reflectors together with a robust estimation scheme. First, we use range FFT to isolate reflectors at different ranges (FIG. 7A). Multiple reflectors and their corresponding lines are detected (FIG. 7B). Notice from Eqn. (10) that all the peak locations fall on the sinusoidal curve f=−2v cos(θv−ωt_{c})/λ, with amplitude propositional to the speed v, and initial phase being θv. Therefore, we aggregate all the detected peaks from different azimuth angles and perform a sinusoidal curve fitting to estimate v and θv (FIG. 7C). We use the RANSAC to leverage the redundancy in our observations and to mitigate the impact of noise and outliers. It achieves an average error of 8.48 mm/s and 1.09° for v and θv estimations, respectively (FIG. 18).

### 5.3 Efficient Compensation and Imaging

Robot motion introduces an additional displacement \vec{v}·t to the antenna location

$${\vec{p}}_{t}^{a} .$$

Thus, the beamforming algorithm Eqn. (3) can be revised into:

$$B ( \vec{d} , \vec{v} ) = {\sum }_{a , t} {S}_{t}^{a} exp ( j 4 π \frac{\vec{d} \cdot ( {\vec{p}}_{t}^{a} + \vec{v} \cdot t )}{λ} ) . \qquad ( 11 )$$

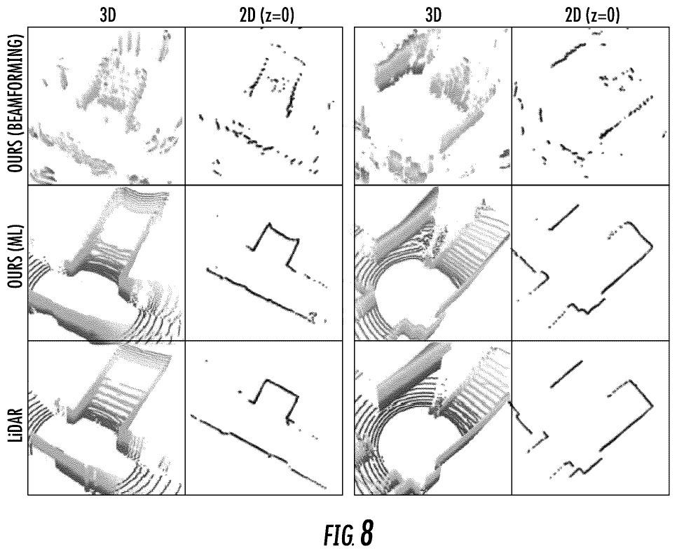

FIG. 8 shows our imaging results with a moving robot, where the environment is captured accurately without distortion. We analyze the complexity of different algorithms below. Θ and φ denote the number of azimuth and elevation angles for imaging, W represents the number of antennas within the sliding window, A is the number of antennas vertically, and N indicates the size of FMCW chirp.

### Phase Steering.

Using Delay-and-sum in our system would have a computational complexity of O(ΘφWAN²).

### 2D Beamforming.

Using beamforming (11) followed by range FFT has a complexity of O(ΘφWAN log N).

### Consecutive 1D Beamforming.

We re-write (11) into:

$$B ( \vec{d} , \vec{v} ) = {\sum }_{t} {S}_{t}^{′} exp ( j 4 π {\vec{d}}^{′} \cdot ( {\vec{p}}_{t}^{′} + {\vec{v}}^{′} \cdot t ) / λ ) , \qquad ( 12 )$$

$${S}_{t}^{′} = {\sum }_{a} {S}_{t}^{a} exp ( \frac{j 4 π {h}^{a} sin {ϕ}_{d}}{λ} )$$

Where \vec{d}′,

$${\vec{p}}_{t}^{′}$$

and \vec{v}′ are the first two dimensions of \vec{d},

$${\vec{p}}_{t}^{a}$$

and \vec{v}, respectively. It shows that the compensation in elevation is independent of that in azimuth. This approach is effectively performing two consecutive steps of 1D beamforming, with a total complexity of O(ΘφAN+ΘφW N log N)=O(ΘφW N log N) given that W>>A.

### 6 ENHANCED IMAGING WITH ML

Through signal processing alone, PanoRadar has achieved fine-grained resolution in both the azimuth and range dimensions. However, the elevation resolution remains limited, especially when compared to the other dimensions (FIG. 8). While this difference seems challenging to mitigate, it offers a unique opportunity when viewed through the lens of machine learning. Notably, given the structural properties inherent in 3D environments, spatial dimensions are not independent. For instance, consistent depth cues from surfaces, as well as gravitational constraints, provide cross-dimensional information. Effectively harnessing these dependencies could enhance the elevation resolution given high azimuth and range resolutions. In this section, we describe the design of our model to enhance elevation resolution and address the challenges arising from the unique characteristics of RF signals (§ 6.1). We also describe various downstream applications enabled by our high-resolution RF images (§ 6.2).

6.1 Resolution Enhancement with ML

Our learning adopts a cross-modal strategy, with paired RF and LiDAR data as inputs and targets for the training. We compute RF inputs using beamforming (§ 5.2). We query beams to match the LiDAR's grid of azimuth and elevation angles. This results in RF tensors of size 512×64×256 (i.e., azimuth×elevation×range). It is important to note that the number of elevation angles does not reflect the elevation resolution, as evidenced by the over-smoothing observed along the elevation dimension (FIG. 8). Our learning target from 3D panoramic LiDAR can be viewed either as sparse 3D point clouds or as dense 2D range maps of size 512×64.

### 3D Learning Via 2D Convolutions.

Unlike previous studies that treat range as a spatial dimension for convolution, our model regards the range as the channel dimension. This allows us to process our 3D RF inputs with 2D CNN models. While conventional CNNs typically expand channel dimensions in the initial layer to extract high-dimensional features, our model aims to compress the sparse signals along the range dimension (by 4×), enhancing learning efficiency. Furthermore, our model adopts the 2D range map representation of LiDAR data as the learning target, enabling the whole cross-modal learning to operate with 2D convolutions. Compared to its 3D CNN counterpart, our 2D model is more memory and computationally efficient. Moreover, 2D CNNs are less prone to overfitting when learning sparse 3D structures from sparse 3D RF inputs.

### Handling Multipath Effect.

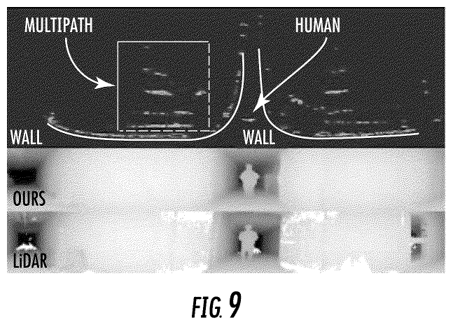

Learning the range of the first reflector as captured by LiDAR yields an opportunity to mitigate the multipath effect that is predominant in indoor environments. By emulating a modality less susceptible to multipath effects, our RF-based model learns to associate the reflections in the RF data to be able to mitigate multipath interference. FIG. 9 shows a multipath-rich corridor where our system accurately senses the 3D environment and the person, without being affected by the multipath reflections.

### Handling Glass

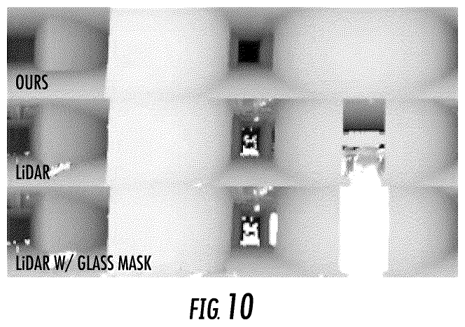

During cross-modality learning, it is crucial to account for the intrinsic differences between how RF and LiDAR interact with glass (e.g., windows, glass doors). While LiDAR cannot detect glass due to its optical properties, glass is opaque to mmWave signals. We incorporate a glass mask and employ a masked L1 loss to ensure our RF-based model remains robust and isn't misled by supervisory signals in those regions. The glass masks were collected together with other semantic labels for segmentation described in § 6.4. As a result of its training, PanoRadar can detect transparent glass (FIG. 10), showcasing the potential of RF imaging to enhance robotic collision avoidance by identifying transparent obstacles like glass doors or windows.

### Capturing Details

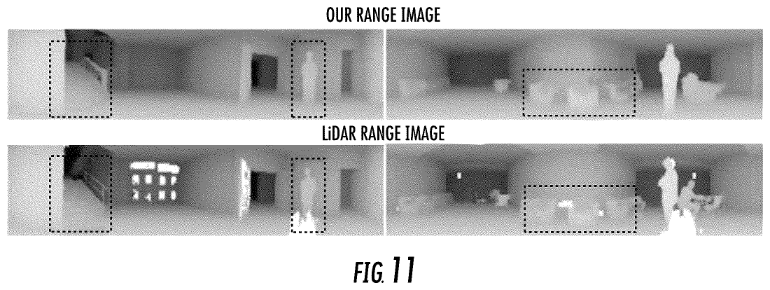

L1 loss tends to produce median-like effects, which can lead to smooth predictions. Training with L1 loss alone would fail to capture high-frequency details. We incorporate perceptual loss into our training. This ensures a more faithful recovery of high-fidelity range images, which is crucial for effective visual recognition tasks. We employed LPIPS with learnable weights for features at different layers. FIG. 11 shows that our approach effectively captures object details including humans and stairs.

6.2 Visual Recognition with ML

With enhanced RF resolution close to that of LiDAR, PanoRadar captures a comprehensive understanding of the surroundings. This enables various downstream tasks, including the first set of visual recognition applications with RF signals.

Surface Normal is crucial for visual perception and robotics tasks like SLAM. Obtaining an accurate range map is essential for capturing surface normals, as small errors in depth can result in significant deviations in the normal directions. We add an additional convolutional layer to our resolution-enhancement model to predict surface normal vectors. We use LiDAR to derive ground truth for training. To visualize surface normal, we use a standard color mapping that linearly maps the xyz values to RGB.

Semantic Segmentation provides pixel-level scene understanding. We employ one of the state-of-the-art methods that does not involve transformers. We observed that vision transformers did not provide additional benefits, possibly due to the small elevation dimension (i.e., 64) of our data. We use pre-trained ResNet-101 as our backbone, which transfers the rich multi-scale features present in natural images to our RF-based range images. Our model is trained to predict 11 semantic classes: table/chair, human, trashcan, railing, door, elevator, stairs, wall, window, floor, and ceiling.

Object Detection has applications in robot navigation, warehouse management, HCl, etc. We use the same ResNet backbone for semantic segmentation, with a Feature Pyramid Network (FPN) and a Faster R-CNN for detection. Our objective is to accurately predict bounding boxes for human class and other non-human objects within the scene.

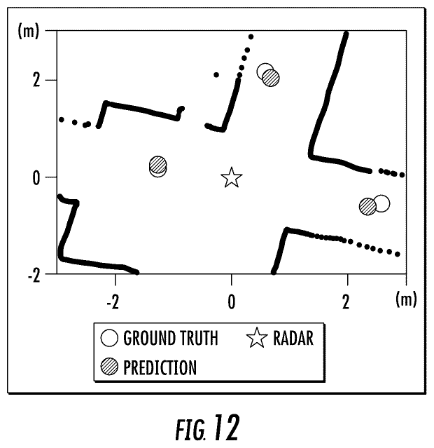

Human Localization could be achieved as a byproduct of object detection. Specifically, we infer azimuth from human bounding box coordinates and range from the predicted depth inside this bounding box (FIG. 12). This approach provides a novel perspective of solving RF-based indoor human localization, as it inherently overcomes the multi-path problem that is challenging in device-free localization.

### 6.3 Panoramic Learning

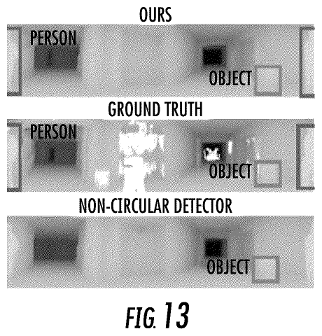

A unique attribute of our input images is that they are panoramic by nature. Our model therefore has the opportunity to be optimized to utilize features that cross the left and right boundaries of the input. Traditional learning methods will not be able to identify and take advantage of these features. For example, an object could be split at the boundary of an image, but current detection models would predict two separate bounding boxes at each end with possible misclassification or miss completely since neither split provides enough features for recognition (the person in FIG. 13). This will lead to a decreased detection performance, a problem similar to the one faced in [21].

We make the following changes to our model to take advantage of the panoramic nature of our data: 1) apply circular padding instead of typical zero padding along azimuth for all convolution layers; 2) disable bounding box clamping for azimuth dimension; 3) revise IoU calculation by taking cross-boundary bounding boxes into account; 4) modify Region of Interest (ROI) pooling technique to first duplicate the feature maps horizontally before applying the pooling. We evaluate the impact of panoramic learning and find it provides consistent gains for all our learning tasks (§ 8).

### 6.4 Ground Truth Labels

For semantic and object labels, we use an active learning strategy. We start with Segment Anything Model, a promptable tool, to aid the manual annotation of semantic labels. Meanwhile, we extracted object boxes by taking the semantic connected components with manual correction. This process was applied to the first 10% of the data. Next, we developed a semantic and object annotation model identical to the one in § 6.2 to generate semi-annotated data, which again underwent human corrections. We refined the model iteratively with additional corrected annotations. With each iteration, the model's accuracy improved, diminishing the need for human correction. Upon reaching 50% annotations, we deployed the model to infer labels on the remaining data. Collectively we have 11,033 semantic and surface normal annotated images, together with 20,546 object instances.

### 7 IMPLEMENTATION AND DATASET

In this section, we describe the implementation details of PanoRadar, and the dataset used for training and evaluation.

### Hardware

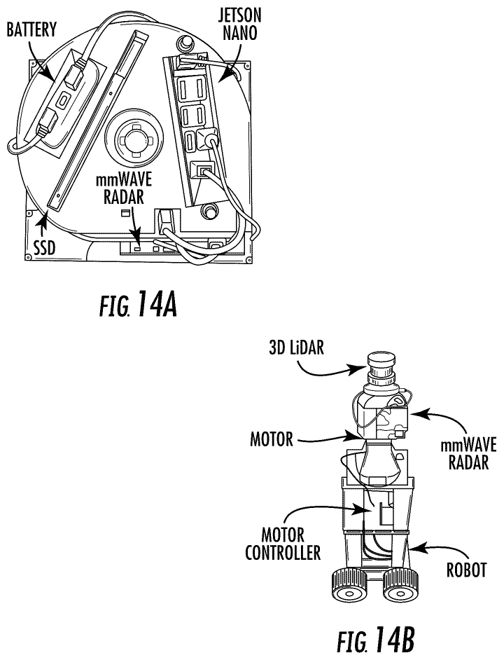

FIG. 14A shows the hardware design of our system. We use a TI AWR1843 single-chip mmWave FMCW radar, with a DCA1000EVM data capture board. We configure our radar to sweep from 77 to 81 GHz with a bandwidth of 4 GHz. Each chirp has 256 samples, with a 10 m maximum sensing range. A single board computer (i.e., Jetson Nano) records the raw samples. We use a Nema 23 stepper motor to drive the rotary part at 2 Hz. The rotation radius is set at 8 cm. Besides, an Ouster 64-beam LiDAR is used to provide ground truth. All cases and supporting parts are 3D printed. Our system is mounted on a Lynxmotion Mecanum Rover mobile platform, as shown in FIG. 14B.

### Neural Networks

Our resolution enhancement model is structured into 7 stages, each with 4 ResNet blocks. The channel count for each stage is determined by a factor of (1, 2, 4, 8, 8, 8, 8) relative to the stem output channels. We train our model using AdamW with an initial learning rate of 10⁻³, decaying by a factor of 0.1 at 50 k and 80 k iterations. Weight α for perceptual loss is 0.1. Our semantic segmentation model is trained using hard-pixel-mining loss with label smoothing of 0.1. For object detection, we use an NMS threshold of 0.7 during training, and 0.5 during inference.

### Dataset

We collected a large dataset that includes a total of 11,033 synchronized RF and LiDAR data spanning across 12 distinct buildings, constructed over a span of a century (from 1906 to 2013). Each building possesses unique features, showcasing materials and designs indicative of their respective eras. The dataset after processing amounts to 461 GB.

### 8 EVALUATION

In this section, we evaluate the performance of PanoRadar. Training & Testing Split. We evaluated all machine learning methods with a cross-building approach to ensure the generalization of our model. Specifically, we left out each building for testing while using the rest for training, repeating this process 12 times, once for each building.

### Range Image Accuracy

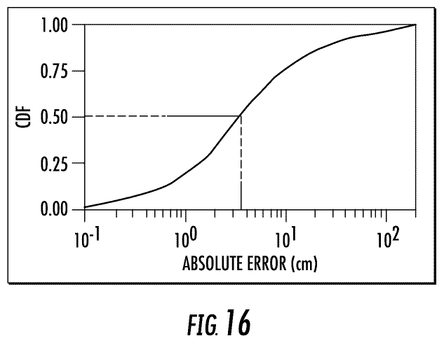

The range image is the core output of PanoRadar for capturing the surrounding 3D structure. When compared against LiDAR ground truth, our model achieves a mean absolute error (MAE) of 15.76 cm. FIG. 16 shows the cumulative distribution function (CDF) of the error for the predicted range image. Notably, the median error is a mere 3.39 cm, suggesting that over half of the predictions are within this tight error margin. Our 90th-percentile error is 31.98 cm, and a large portion of the tail error can be attributed to inaccurate boundaries between foreground and background objects, which has limited impact for applications that do not require pixel-level accuracy.

Table 1 presents per-building performance for this task, showing that our model is robust to variations in the building environments. Point Cloud Accuracy. An alternative method of evaluating our predicted range results is to compare them against the ground truth in a 3D point cloud space. CFAR is used to retrieve the point clouds from RF heatmaps, and this intermediate result is also evaluated against the ground truth. We evaluate our system using mean Chamfer Distance (CD) and a mean modified Housdorff Distance (HD), both of which are commonly used methods for point cloud comparisons. These errors are summarized in Table 3. Overall, our system obtains highly accurate 3D point clouds at a mean CD of 6.96 cm and a mean modified HD of 3.23 cm. When comparing the results with and without machine learning, we see that machine learning results provide significant gains in performance compared to the signal processing results (Table 3). This verifies that the deep model helps mitigate artifacts such as multipath and side lobe leakage captured in the raw signal, significantly improving the sensing resolution and refining the imaging results.

TABLE 1
The building information (sorted by year of construction) and our system's cross-building generalization performance

| Building # | 1 | 2 | 3 | 4 | 5 | 6 | 7 | 8 | 9 | 10 | 11 | 12 |
|---|---|---|---|---|---|---|---|---|---|---|---|---|
| Year of | 1906 | 1913 | 1925 | 1940 | 1954 | 1966 | 1967 | 1971 | 1987 | 1996 | 2006 | 2013 |
| Construction | | | | | | | | | | | | |
| Range Image | 12.62 | 13.77 | 16.40 | 20.25 | 11.19 | 13.34 | 10.36 | 30.27 | 12.23 | 16.24 | 16.12 | 19.20 |
| MAE (cm) | | | | | | | | | | | | |
| Surface Normal | 7.63 | 8.68 | 9.65 | 10.17 | 6.88 | 8.83 | 9.47 | 9.92 | 9.31 | 9.90 | 8.27 | 8.79 |
| MAE (°) | | | | | | | | | | | | |
| Object | 57.20 | 52.11 | 64.88 | 35.64 | 51.17 | 67.47 | 65.48 | 44.20 | 58.50 | 61.71 | 65.97 | 50.03 |
| Detection | | | | | | | | | | | | |
| AP³⁰ | | | | | | | | | | | | |
| Semantic | 51.11 | 51.03 | 50.07 | 47.02 | 52.23 | 46.30 | 38.77 | 45.69 | 53.58 | 45.64 | 39.50 | 38.87 |
| Segmentation | | | | | | | | | | | | |
| mIoU | | | | | | | | | | | | |

### Visual Recognition Performance

We evaluate the performance of visual recognition with the enhanced RF imaging resolution. For surface normal estimation, we observe a MAE of 8.83° and a notably lower median error of 2.17° (Table 2). Attaining such precision allows for advanced indoor robotics applications that require surface analysis, such as 3D scene reconstruction. In addition, our semantic recognition model achieves a mIoU of 48.00 across 11 classes, demonstrating that our RF images capture rich information and enable ML models to recognize distinct semantic regions. It paves the way for more advanced RF-based scene understanding where ML models can further analyze surfaces with different reflection characteristics. Finally, our object detector achieves an AP³⁰ score of 52.33, and an AP⁵⁰ of 38.30, making it suitable for applications including collision avoidance.

TABLE 2
The overall performance of our surface normal estimation, object
detection, semantic segmentation and 2D human localization.

| | | | | | | | Human | |
|---|---|---|---|---|---|---|---|---|
| Surface Normal Error | | | Object | | Semantic | | Localization | |
| | | 90^{th}^{_{—}} | Detection | | Segmentation | | Error | |
| mean | median | percentile | AP³⁰ | AP⁵⁰ | mIoU | pAcc | mean | median |
| 8.83° | 2.17° | 28.10° | 52.34 | 38.30 | 48.00 | 86.33 | 12.24 cm & | 5.78 cm & |
| | | | | | | | 1.47° | 1.08° |

TABLE 3
RF imaging point cloud error with and without machine learning.

| | CD (2D) | CD (3D) | HD (2D) | HD (3D) |
|---|---|---|---|---|
| Beamforming | 21.4 cm | 26.6 cm | 12.8 cm | 12.0 cm |
| only | | | | |
| Beamforming + | 7.43 cm | 6.96 cm | 3.12 cm | 3.23 cm |
| ML | | | | |

(CD: Chamfer Distance, HD: Modified Housdorff Distance)

### Human Localization Performance

Our system can perform 2D human localization and achieves an average error of 12.24 cm along range and 1.47 degrees along azimuth (Table 2). This performance is comparable to state-of-the-art device-free localization methods. This level of precision can be applied to various applications like patient monitoring and smart home automation.

### Qualitative Results.

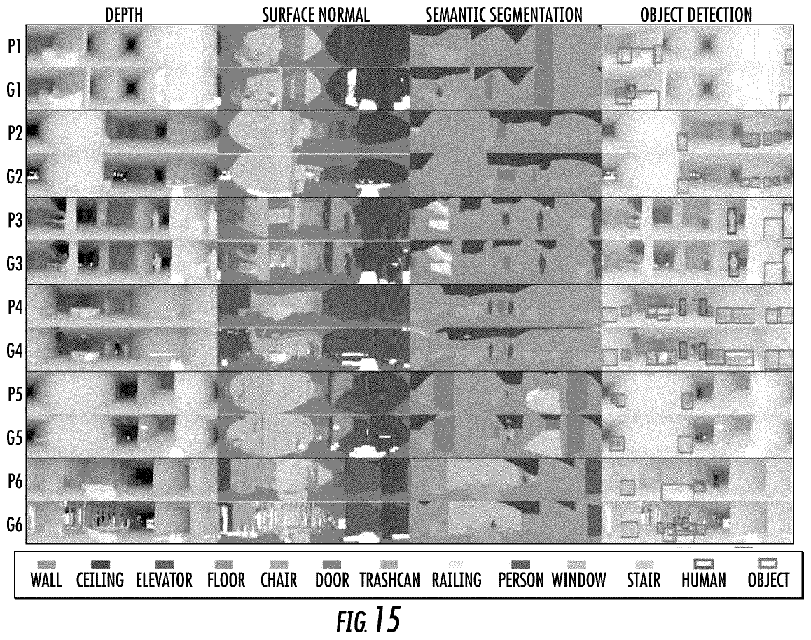

FIG. 15 shows qualitative results of our system's performance across many diverse buildings. We remark that the RF-based range images preserve high-frequency details (e.g., chair, railing, stairs) without many of the artifacts of LiDAR (e.g., failed regions, cannot handle transparent surfaces, cannot see through smoke, etc.). For example, the details on the stairs in row P5 are well defined, which translates to impressive surface normal and segmentation results. Furthermore, small objects like the chairs in P2 are also seen by our range image, leading to accurate object detection. Our model also demonstrates robustness to dense environments, as evident in P4, where many chairs close together are segmented and detected with high precision. Motion Estimation Accuracy. We evaluate our proposed robot motion estimation by comparing it with the LiDAR ground truth derived using iterative closest point. Our robot operates with a maximum speed of 0.6 m/s and an average speed of 0.39 m/s, typical for indoor robots. FIG. 18 shows the evaluation results for the 12 individual buildings. The MAE of speed estimation is 8.48 mm/s and that of the direction estimation is 1.09°. Our motion estimation errors, both in terms of the speed and direction, remain similar across these diverse environments. This shows that our method is not only accurate (achieving millimeter-level accuracy), but also very robust, a key feature for robotic applications.

Imaging Performance versus Motion Estimation Errors

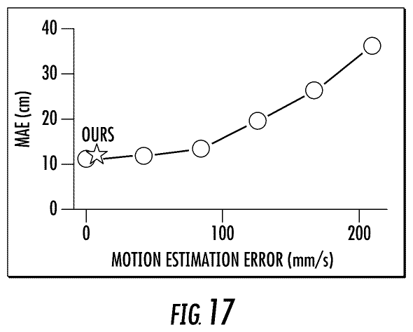

To understand how our imaging model performs with different amounts of error in motion estimation, we introduce synthesized motion estimation errors incrementally to the ground truth and evaluate the model's performance. FIG. 17 shows that it is resistant to certain amount of motion estimation error. Given the actual performance of our motion estimation algorithm (i.e., 8.48 mm/s), our ML models are able to maintain robust and accurate imaging results across a variety of scenarios.

Imaging Performance versus Sensing Distance

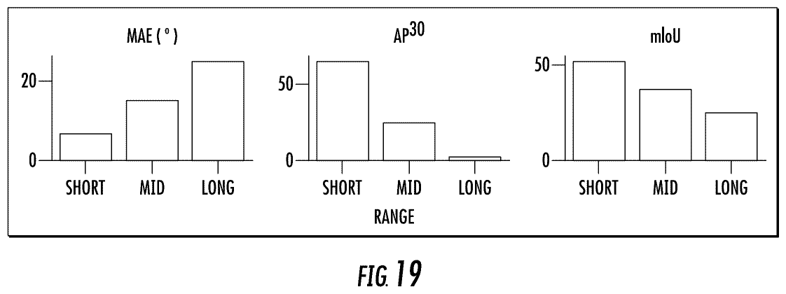

Based on the distances relative to the radar's position, we split our imaging performance into 3 categories-short, mid, and long as depicted in FIG. 19. A clear trend emerging from the data is that performance drops off with greater distances. This is inevitable as our RF sensing resolution is still affected by the reduced signal strength and low SNR at long range. However, some tasks are more resilient. For instance, semantic segmentation may use semantic features to infer nearby pixels, maintaining continuity. For indoor applications or environments where long-range accuracy is not critical, our system demonstrates its strong performance.

### Effect of Panoramic Learning

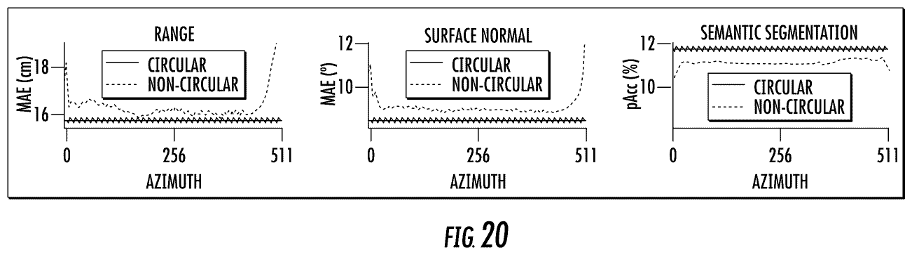

FIG. 20 shows the impact of panoramic learning for range imaging, surface normal, and semantic segmentation. To evaluate this, we rotated each test image horizontally 512 times, one column at a time and averaged the errors column-wise. As depicted, our circular model maintains a constant high performance across all orientations of the image, whereas the non-circular model sees drops in performance towards the horizontal edges.

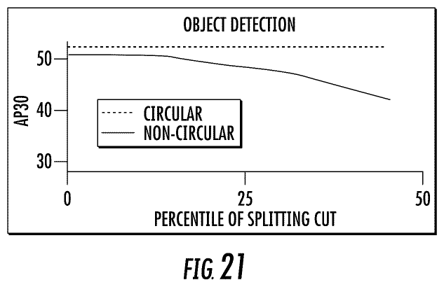

We design a separate test to evaluate our panoramic object detection. Since our dataset does not feature many bounding boxes crossing the boundary, we intentionally rotate our test images to ensure each image presents at least one bounding box that is split at the image boundary. We vary the percentile of box width on which we split the boxes and assess the performance of both circular and non-circular models. As shown in FIG. 21, our results indicate that the circular model performs consistently well across various percentiles of partial boxes on both ends, given its ability to always capture the complete circular scene. In contrast, the non-circular model exhibits a decrease in performance, with the most significant drop observed when the split occurs at the 50th percentile. These experiments demonstrate the strengths of utilizing the unique circular features of our input.

### Angular Resolution.

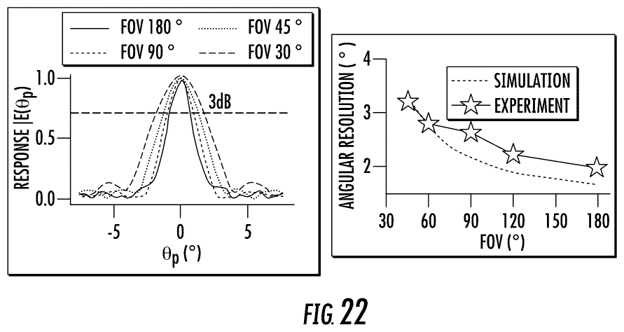

§ 4 provides a way to analyze the angular resolution of circular arrays with omni-directional antennas. However, the antennas we used in the system are directional and thus have a limited FOV. To simulate the response E(s) of the point reflector in Eqn. (5), we adopt the antenna radiation pattern given in and limit the integration interval to different FOVs. FIG. 22 (left) presents the simulation of the response E(Os) with different FOV. With a larger FOV, the beamwidth of the main lobe gets smaller, indicating a better angular resolution. However, as the FOV reaches angles greater than 90°, the rate of shrinkage of the beamwidth decreases. Since a larger FOV also requires more operations, we make a trade-off between imaging speed and resolution, choosing 90° as the FOV for our system.

To test the azimuth angular resolution of our system, we design experiments that two small reflectors are kept 1 meter away from the radar rotation center and separated with different angles. We then record the minimum angle that separates the two individual peaks with its 3-dB beamwidth in the imaging result as the azimuth resolution. As shown in FIG. 22 (right), the angular resolution from experiments is consistent with that in the simulation. The small errors may come from the disagreement with the typical antenna radiation pattern we adopted and the actual one, and also the influence of other objects in the environment.

### 9 LIMITATIONS AND FUTURE WORK

While PanoRadar has advanced the capabilities of RF imaging systems, it is important to understand its limitations. First, our study has been focused on indoor robots and environments. Although we anticipate that this approach could generalize to other settings, such as warehouses, shopping malls, and even autonomous driving scenarios, these applications remain exciting topics for future studies. Second, the commercial COTS radar used in our system has only eight antennas in an array. Utilizing a radar with a greater number of antennas would lead to higher elevation resolution, potentially enhancing the overall accuracy of the system or achieving the same level of resolution with smaller ML models. Lastly, our system is designed to learn first-reflection range images and is trained to ignore multipath reflections. As a result, it cannot leverage these reflections for applications that require seeing through or around capabilities. Developing a method to take advantage of multipath reflections while maintaining the efficiency and robustness of learning presents an interesting avenue for future research.

### 10 CONCLUSION

PanoRadar introduces a novel RF imaging approach that narrows the resolution gap between RF and LiDAR, enabling a range of visual recognition tasks at radio frequency, including surface normal estimation, semantic segmentation, and object detection. These new capabilities, combined with high-resolution 3D images of the surroundings, open up a multitude of applications that were traditionally only possible with cameras. We believe PanoRadar marks a significant step forward in RF imaging. We anticipate that this work, along with the released dataset, will encourage further research and development in RF-based imaging technologies, providing a robust yet cost-effective alternative to existing imaging technologies such as LiDAR and cameras.

### A Derivation of Equations

### Equation 4

Similar to the analysis for linear arrays:

$$\begin{matrix}E ( {θ}_{s} ) = {\int }_{0}^{2 π} \frac{exp \{ j 2 π ( R - r cos ( {θ}_{s} - θ ) / λ \}}{exp \{ j 2 π ( R - r cos θ ) / λ \}} d θ \\ = {\int }_{0}^{2 π} exp \{ j 2 πr ( cos θ - cos ( {θ}_{s} - θ ) ) / λ \} d θ .\end{matrix} \qquad ( 13 )$$

Substituting cos θ−cos(θs−θ) with

$$2 sin \frac{{θ}_{s}}{2} sin ( \frac{{θ}_{s}}{2} - θ ) , we get E ( {θ}_{s} ) = {\int }_{0}^{2 π} exp ( jm sin ( \frac{{θ}_{s}}{2} - θ ) ) d θ ,$$

where

$$m = \frac{4 π r}{λ} sin \frac{{θ}_{s}}{2} .$$

Since it integrates over a full period, thus:

$$E ( {θ}_{s} ) = {\int }_{0}^{2 π} exp ( jm sin ( θ ) ) d θ .$$

Based on the definition of the Bessel function of the first kind, we arrive at Eqn. (4).

### Equation 6

Given the antenna location

$${\vec{p}}_{r}^{a} = ( r cos ω t + v t cos {θ}_{v} , r sin ω t + v t sin {θ}_{v} , 0 )$$

and reflector location (Rₙ cos θₙ, Rₙ sin θₙ, 0). The square of their distance is [Rₙ−rcos(ωt−θₙ)−vtcos(θᵥ−θₙ)]²+Q, where Q=r² sin²(ωt−θₙ)+v²t² sin²(θᵥ−θₙ)+2rvtsin(ωt−θₙ) sin(θᵥ−θₙ). Since r², (vt)², and rvt are small compared to

$${R}_{n}^{2} ,$$

the term Q can be neglected, resulting in Eqn. (6).

### Equation 8

Expanding Equation (7):

$${d}^{′} ( t , {t}_{c} ) = {R}_{n} - vt cos ( {θ}_{v} - {θ}_{n )} - 2 r sin \frac{ω {t}_{c} - {θ}_{n}}{2} sin \frac{ω {t}_{c} - 2 ω t + {θ}_{n}}{2} .$$

Since reflector is only observed within the FoV of the radar. Hence, ωt_{c}−θₙ, ωt_{c}−ωt, and θₙ−ωt are relatively small (<30°) so that sinx≈x. Therefore,

$${d}^{′} ( t , {t}_{c} ) \approx {R}_{n} - vt cos ( {θ}_{v} - {θ}_{n )} - \frac{r}{2} ( ω {t}_{c} - {θ}_{n} ) ( ω {t}_{c} - 2 ω t + {θ}_{n} ) = r ω t ( ω {t}_{c} - {θ}_{n} ) - vt cos ( {θ}_{v} - {θ}_{n} ) + const .$$

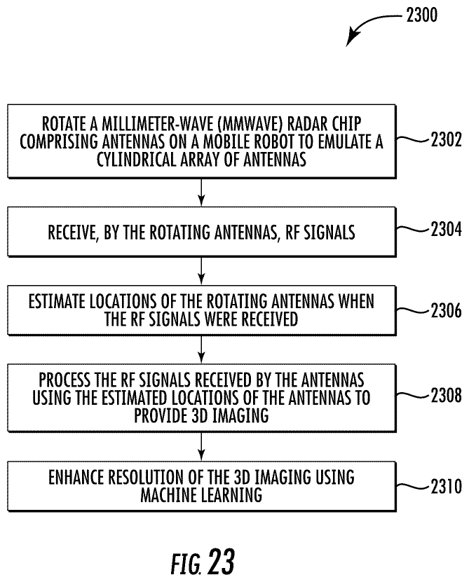

FIG. 23 is a flow diagram of an example method 2300 for providing 3D imaging using radio frequencies. At step 2302, a millimeter-wave (mmWave) radar chip comprising antennas on a mobile robot is rotated to emulate a cylindrical array of antennas.

At step 2304, RF signals are received by the rotating antennas.

At step 3406, locations of the rotating antennas when the RF signals were received are estimated. Estimating the locations can include determining a motion of the robot. The locations of the antennas can be estimated to a subwavelength location accuracy.

At step 2308, the RF signals received by the antennas are processed using the estimated locations of the antennas to provide 3D imaging.

At step 2310, resolution of the 3D imaging is enhanced using machine learning. Vertical imaging can be interpolated using the processed RF signals and machine learning. The RF signals can be compressed along a range dimension using two-dimensional (2D) Convolutional Neural Networks (CNNs). Additional optional steps can include recognizing objects in the 3D imaging. Enhancing resolution of the 3D imaging can include detecting transparent glass. The machine learning can include a model trained with RF data and LiDAR data of targets.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

The disclosure of each of the following references is incorporated herein by reference in its entirety.

### REFERENCES

[1] Fadel Adib, Zachary Kabelac, and Dina Katabi. 2015. Multi-person localization via RF body reflections. In 12th USENIX Symposium on Networked Systems Design and Implementation (NSDI 15). 279-292.
[2] Fadel Adib, Zach Kabelac, Dina Katabi, and Robert C Miller. 2014. 3D tracking via body radio reflections. In 11th USENIX Symposium on Networked Systems Design and Implementation (NSDI 14). 317-329.
[3] Aditya Arun, Roshan Ayyalasomayajula, William Hunter, and Dinesh Bharadia. 2022. P2SLAM: Bearing Based WiFi SLAM for Indoor Robots. IEEE Robotics and Automation Letters 7, 2 (2022), 3326-3333. https: //doi.org/10.1109/LRA.2022.3144796.
[4] Roshan Ayyalasomayajula, Aditya Arun, Chenfeng Wu, Sanatan Sharma, Abhishek Rajkumar Sethi, Deepak Vasisht, and Dinesh Bharadia. 2020. Deep Learning Based Wireless Localization for Indoor Navigation (MobiCom '20). Association for Computing Machinery, New York, NY, USA, Article 17, 14 pages. https://doi.org/10.1145/3372224.3380894
[5] Hernan Badino, Daniel Huber, Yongwoon Park, and Takeo Kanade. 2011. Fast and accurate computation of surface normals from range images. In 2011 IEEE International Conference on Robotics and Automation. IEEE, 3084-3091.
[6] Kshitiz Bansal, Keshav Rungta, Siyuan Zhu, and Dinesh Bharadia. 2020. Pointillism: Accurate 3d bounding box estimation with multi-radars. In Proceedings of the 18th Conference on Embedded Networked Sensor Systems. 340-353.
[7] Dan Barnes, Matthew Gadd, Paul Murcutt, Paul Newman, and Ingmar Posner. 2020. The oxford radar robotcar dataset: A radar extension to the oxford robotcar dataset. In 2020 IEEE International Conference on Robotics and Automation (ICRA). IEEE, 6433-6438.
[8] Paul J Besl and Neil D McKay. 1992. Method for registration of 3D shapes. In Sensor fusion IV: control paradigms and data structures, Vol. 1611. Spie, 586-606.
[9] Thomas Beyer, David W Townsend, Tony Brun, Paul E Kinahan, Martin Charron, Raymond Roddy, Jeff Jerin, John Young, Larry Byars, and Ronald Nutt. 2000. A combined PET/CT scanner for clinical oncology. Journal of nuclear medicine 41, 8 (2000), 1369-1379.
[10] Tara Boroushaki, Isaac Perper, Mergen Nachin, Alberto Rodriguez, and Fadel Adib. 2021. RFusion: Robotic Grasping via RF-Visual Sensing and Learning. In Proceedings of the 19th ACM Conference on Embedded Networked Sensor Systems (Coimbra, Portugal) (SenSys '21). Association for Computing Machinery, New York, NY, USA, 192-205. https://doi.org/10.1145/3485730.3485944
[11] Martin Brossard and Silvere Bonnabel. 2019. Learning wheel odometry and IMU errors for localization. In 2019 International Conference on Robotics and Automation (ICRA). IEEE, 291-297.
[12] Keenan Burnett, Angela P Schoellig, and Timothy D Barfoot. 2021. Do we need to compensate for motion distortion and doppler effects in spinning radar navigation?IEEE Robotics and Automation Letters 6, 2 (2021), 771-778.
[13] Keenan Burnett, David J Yoon, Yuchen Wu, Andrew Zou Li, Haowei Zhang, Shichen Lu, Jingxing Qian, Wei-Kang Tseng, Andrew Lambert, Keith YK Leung, et al. 2022. Boreas: A multi-season autonomous driving dataset. arXiv preprint arXiv:2203.10168 (2022).
[14] Emmanuel J Candes and Yaniv Plan. 2010. Matrix completion with noise. Proc. IEEE 98, 6 (2010), 925-936.
[15] Liang-Chieh Chen, George Papandreou, lasonas Kokkinos, Kevin Murphy, and Alan L. Yuille. 2018. DeepLab: Semantic Image Segmentation with Deep Convolutional Nets, Atrous Convolution, and Fully Connected CRFs. IEEE Transactions on Pattern Analysis and Machine Intelligence 40, 4 (2018), 834-848. https://doi.org/10.1109/TPAMI.2017. 2699184
[16] Liang-Chieh Chen, George Papandreou, Florian Schroff, and Hartwig Adam. 2017. Rethinking atrous convolution for semantic image segmentation. arXiv preprint arXiv:1706.05587 (2017).
[17] Liang-Chieh Chen, Yukun Zhu, George Papandreou, Florian Schroff, and Hartwig Adam. 2018. Encoder-decoder with atrous separable convolution for semantic image segmentation. In Proceedings of the European conference on computer vision (ECCV). 801-818.
[18] Rodney Coleman. 2018. 21. Probability Theory, an Analytic View. Journal of the Royal Statistical Society Series A: Statistics in Society 158, 2 (12 2018), 356-357. https://doi.org/10.2307/2983317 arXiv:https://academic.oup.com/jrsssa/articlepdf/158/2/356/49759996/jrsssa_158_2_356a.pdf
[19] PDAL Contributors. 2022. PDAL Point Data Abstraction Library. https://pdal.io/en/latest/apps/chamfer.html
[20] PDAL Contributors. 2022. PDAL Point Data Abstraction Library. https://pdal.io/en/latest/apps/hausdorff.html
[21] Greire Payen de La Garanderie, Amir Atapour Abarghouei, and Toby P Breckon. 2018. Eliminating the blind spot: Adapting 3d object detection and monocular depth estimation to 360 panoramic imagery. In Proceedings of the European Conference on Computer Vision (ECCV). 789-807.
[22] Amit Dhiman, Neel Shah, Pranali Adhikari, Sayali Kumbhar, Inderjit Singh Dhanjal, and Ninad Mehendale. 2022. Firefighting robot with deep learning and machine vision. Neural Computing and Applications (2022), 1-9.
[23] Richard O Duda and Peter E Hart. 1972. Use of the Hough transformation to detect lines and curves in pictures. Commun. ACM 15, 1 (1972), 11-15.
[24] Shiwei Fang and Shahriar Nirjon. 2020. Superrf: Enhanced 3d rf representation using stationary low-cost mmwave radar. In International Conference on Embedded Wireless Systems and Networks (EWSN) . . . , Vol. 2020. NIH Public Access, 120.
[25] Martin A. Fischler and Robert C. Bolles. 1981. Random Sample Consensus: A Paradigm for Model Fitting with Applications to Image Analysis and Automated Cartography. Commun. ACM 24, 6 (jun 1981), 381-395. https://doi.org/10.1145/358669.358692
[26] Mohammad Tayeb Ghasr, Matthew J. Horst, Matthew R. Dvorsky, and Reza Zoughi. 2017. Wideband Microwave Camera for Real-Time 3-D Imaging. IEEE Transactions on Antennas and Propagation 65, 1 (2017), 258-268. https://doi.org/10.1109/TAP.2016.2630598
[27] Ross Girshick. 2015. Fast r-cnn. In Proceedings of the IEEE international conference on computer vision. 1440-1448.
[28] Ross Girshick, Jeff Donahue, Trevor Darrell, and Jitendra Malik. 2014. Rich feature hierarchies for accurate object detection and semantic segmentation. In Proceedings of the IEEE conference on computer vision and pattern recognition. 580-587.
[29] Thomas Gisder, Marc-Michael Meinecke, and Erwin Biebl. 2019. Synthetic aperture radar towards automotive applications. In 2019 20th International Radar Symposium (IRS). IEEE, 1-10.
[30] Jorgen Grythe and AS Norsonic. 2015. Beamforming algorithmsbeamformers. Technical Note, Norsonic AS, Norway (2015).
[31] Junfeng Guan, Sohrab Madani, Suraj Jog, Saurabh Gupta, and Haitham Hassanieh. 2020. Through fog high-resolution imaging using millimeter wave radar. In Proceedings of the IEEE/CVF Conference on Computer Vision and Pattern Recognition. 11464-11473.
[32] Maki K Habib and Yvan Baudoin. 2010. Robot-assisted risky intervention, search, rescue, and environmental surveillance. International Journal of Advanced Robotic Systems 7, 1 (2010), 10.
[33] Kaiming He, Xiangyu Zhang, Shaoqing Ren, and Jian Sun. 2016. Deep residual learning for image recognition. In Proceedings of the IEEE conference on computer vision and pattern recognition. 770-778.
[34] Texas Instruments. [n. d.]. AWR1843BOOST and IWR1843BOOST Single-Chip mmWave Sensing Solution User's Guide (Rev. B). Texas Instruments. https://www.ti.com/lit/pdf/spruim4
[35] Texas Instruments. [n. d.]. mmWave radar sensors in robotics applications (Rev. A). Texas Instruments. https://www.ti.com/lit/pdf/spry311
[36] Texas Instruments. [n. d.]. Real-time data-capture adapter for radar sensing evaluation module. Texas Instruments. http://www.ti.com/tool/DCA1000EVM
[37] Wenjun Jiang, Hongfei Xue, Chenglin Miao, Shiyang Wang, Sen Lin, Chong Tian, Srinivasan Murali, Haochen Hu, Zhi Sun, and Lu Su. 2020. Towards 3D Human Pose Construction Using Wifi. In Proceedings of the 26th Annual International Conference on Mobile Computing and Networking (London, United Kingdom) (MobiCom '20). Association for Computing Machinery, New York, NY, USA, Article 23, 14 pages. https://doi.org/10.1145/3372224.3380900
[38] Kiran Joshi, Dinesh Bharadia, Manikanta Kotaru, and Sachin Katti. 2015. Wideo: Fine-grained device-free motion tracing using RF backscatter. In 12th USENIX Symposium on Networked Systems Design and Implementation (NSDI 15). 189-204.
[39] Alexander Kirillov, Eric Mintun, Nikhila Ravi, Hanzi Mao, Chloe Rolland, Laura Gustafson, Tete Xiao, Spencer Whitehead, Alexander C Berg, Wan-Yen Lo, et al. 2023. Segment anything. arXiv preprint arXiv:2304.02643 (2023).
[40] Hao Kong, Xiangyu Xu, Jiadi Yu, Qilin Chen, Chenguang Ma, Yingying Chen, Yi-Chao Chen, and Linghe Kong. 2022. M3Track: <u>mm</U>wave-Based <u>m</U>ulti-User 3D Posture Tracking. In Proceedings of the 20th Annual International Conference on Mobile Systems, Applications and Services (Portland, Oregon) (MobiSys '22). Association for Computing Machinery, New York, NY, USA, 491-503. https://doi.org/10.1145/3498361.3538926
[41] Daniel Konings, Fakhrul Alam, Frazer Noble, and Edmund M-K. Lai. 2019. Device-Free Localization Systems Utilizing Wireless RSSI: A Comparative Practical Investigation. IEEE Sensors Journal 19, 7 (2019), 2747-2757. https://doi.org/10.1109/JSEN.2018.2888862
[42] Haowen Lai, Peng Yin, and Sebastian Scherer. 2022. Adafusion: Visuallidar fusion with adaptive weights for place recognition. IEEE Robotics and Automation Letters 7, 4 (2022), 12038-12045.
[43] Tianhong Li, Lijie Fan, Mingmin Zhao, Yingcheng Liu, and Dina Katabi. 2019. Making the invisible visible: Action recognition through wallsand occlusions. In Proceedings of the IEEE/CVF International Conference on Computer Vision. 872-881.
[44] Yingwei Li, Adams Wei Yu, Tianjian Meng, Ben Caine, Jiquan Ngiam, Daiyi Peng, Junyang Shen, Yifeng Lu, Denny Zhou, Quoc V Le, et al. 2022. Deepfusion: Lidar-camera deep fusion for multi-modal 3d object detection. In Proceedings of the IEEE/CVF Conference on Computer Vision and Pattern Recognition. 17182-17191.
[45] Tsung-Yi Lin, Piotr Dollár, Ross B. Girshick, Kaiming He, Bharath Hariharan, and Serge J. Belongie. 2016. Feature Pyramid Networks for Object Detection. CoRR abs/1612.03144 (2016). arXiv:1612.03144 http://arxiv.org/abs/1612.03144
[46] Chris Xiaoxuan Lu, Stefano Rosa, Peijun Zhao, Bing Wang, Changhao Chen, John A Stankovic, Niki Trigoni, and Andrew Markham. 2020. See through smoke: robust indoor mapping with low-cost mmwave radar. In Proceedings of the 18th International Conference on Mobile Systems, Applications, and Services. 14-27.
[47] Chris Xiaoxuan Lu, Muhamad Risqi U Saputra, Peijun Zhao, Yasin Almalioglu, Pedro PB De Gusmao, Changhao Chen, Ke Sun, Niki Trigoni, and Andrew Markham. 2020. milliEgo: single-chip mmWave radar aided egomotion estimation via deep sensor fusion. In Proceedings of the 18th Conference on Embedded Networked Sensor Systems. 109-122.
[48] Si Lu, Xiaofeng Ren, and Feng Liu. 2014. Depth Enhancement via Low-Rank Matrix Completion. In 2014 IEEE Conference on Computer Vision and Pattern Recognition. 3390-3397. https://doi.org/10.1109/CVPR.2014.433
[49] Sohrab Madani, Jayden Guan, Waleed Ahmed, Saurabh Gupta, and Haitham Hassanieh. 2022. Radatron: Accurate Detection Using Multiresolution Cascaded MIMO Radar. In 17th European Conference of Computer Vision (ECCV). Springer, 160-178.
[50] Babak Mamandipoor, Greg Malysa, Amin Arbabian, Upamanyu Madhow, and Karam Noujeim. 2014. 60 ghz synthetic aperture radar for short-range imaging: Theory and experiments. In 2014 48th Asilomar Conference on Signals, Systems and Computers. IEEE, 553-558.
[51] Daniel Maturana and Sebastian Scherer. 2015. Voxnet: A 3d convolutional neural network for real-time object recognition. In 2015 IEEE/RSJ international conference on intelligent robots and systems (IROS). IEEE, 922-928.
[52] Andres Milioto, Ignacio Vizzo, Jens Behley, and Cyrill Stachniss. 2019. Rangenet++: Fast and accurate lidar semantic segmentation. In 2019 IEEE/RSJ international conference on intelligent robots and systems (IROS). IEEE, 4213-4220.
[53] Alberto Moreira, Pau Prats-Iraola, Marwan Younis, Gerhard Krieger, Irena Hajnsek, and Konstantinos P. Papathanassiou. 2013. A tutorial on synthetic aperture radar. IEEE Geoscience and Remote Sensing Magazine 1, 1 (2013), 6-43. https://doi.org/10.1109/MGRS.2013.2248301
[54] Navtech. [n. d.]. CTS350-X Radar Specifications. https://navtechradar. com/clearway-technical-specifications
[55] Prasanga Neupane, Guannan Liu, Hsiao-Chun Wu, Weidong Xiang, Shih Yu Chang, and Yiyan Wu. 2021. Novel Device-Free Indoor Human Localization using Wireless Radio-Frequency Fingerprinting. In 2021 IEEE International Symposium on Broadband Multimedia Systems and Broadcasting (BMSB). 1-7. https://doi.org/10.1109/BMSB53066.2021. 9547072
[56] Anurag Pallaprolu, Belal Korany, and Yasamin Mostofi. 2022. Wiffract: a new foundation for RF imaging via edge tracing. In Proceedings of the 28th Annual International Conference on Mobile Computing And Networking (MobiCom). 255-267.
[57] Akarsh Prabhakara, Tao Jin, Arnav Das, Gantavya Bhatt, Lilly Kumari, Elahe Soltanaghai, Jeff Bilmes, Swarun Kumar, and Anthony Rowe. 2023. High Resolution Point Clouds from mmWave Radar. In 2023 IEEE International Conference on Robotics and Automation (ICRA). IEEE, 4135-4142.
[58] Akarsh Prabhakara, Vaibhav Singh, Swarun Kumar, and Anthony Rowe. 2020. Osprey: A MmWave Approach to Tire Wear Sensing. In Proceedings of the 18th International Conference on Mobile Systems, Applications, and Services (Toronto, Ontario, Canada) (MobiSys '20). Association for Computing Machinery, New York, NY, USA, 28-41. https://doi.org/10.1145/3386901.3389031
[59] Charles R Qi, Hao Su, Kaichun Mo, and Leonidas J Guibas. 2017. Pointnet: Deep learning on point sets for 3d classification and segmentation. In Proceedings of the IEEE conference on computer vision and pattern recognition. 652-660.
[60] Charles Ruizhongtai Qi, Li Yi, Hao Su, and Leonidas J Guibas. 2017. Pointnet++: Deep hierarchical feature learning on point sets in a metric space. Advances in neural information processing systems 30 (2017).
[61] Kun Qian, Zhaoyuan He, and Xinyu Zhang. 2020. 3D point cloud generation with millimeter-wave radar. Proceedings of the ACM on Interactive, Mobile, Wearable and Ubiquitous Technologies 4, 4 (2020), 1-23.
[62] Kun Qian, Chenshu Wu, Yi Zhang, Guidong Zhang, Zheng Yang, and Yunhao Liu. 2018. Widar2.0: Passive Human Tracking with a Single Wi-Fi Link. In Proceedings of the 16th Annual International Conference on Mobile Systems, Applications, and Services (Munich, Germany) (MobiSys '18). Association for Computing Machinery, New York, NY, USA, 350-361. https://doi.org/10.1145/3210240.3210314
[63] Pengzhen Ren, Yun Xiao, Xiaojun Chang, Po-Yao Huang, Zhihui Li, Brij B. Gupta, Xiaojiang Chen, and Xin Wang. 2021. A Survey of Deep Active Learning. ACM Comput. Surv. 54, 9, Article 180 (oct 2021), 40 pages. https://doi.org/10.1145/3472291
[64] Shaoqing Ren, Kaiming He, Ross Girshick, and Jian Sun. 2015. Faster r-cnn: Towards real-time object detection with region proposal networks. Advances in neural information processing systems 28 (2015).
[65] Mark A Richards. 2014. Fundamentals of radar signal processing. McGraw-Hill Education.
[66] Kourosh Sartipi, Tien Do, Tong Ke, Khiem Vuong, and Stergios I. Roumeliotis. 2020. Deep Depth Estimation from Visual-Inertial SLAM. In 2020 IEEE/RSJ International Conference on Intelligent Robots and Systems (IROS). 10038-10045. https://doi.org/10.1109/IROS45743.2020. 9341448
[67] Guy Satat, Matthew Tancik, and Ramesh Raskar. 2018. Towards photography through realistic fog. In 2018 IEEE International Conference on Computational Photography (ICCP). IEEE, 1-10.
[68] Guy Satat, Matthew Tancik, and Ramesh Raskar. 2018. Towards photography through realistic fog. In 2018 IEEE International Conference on Computational Photography (ICCP). IEEE, 1-10.
[69] Peter Shirley and Steve Marschner. 2009. Fundamentals of Computer Graphics (3rd ed.). A. K. Peters, Ltd., USA.
[70] Mehrdad Soumekh. 1990. A system model and inversion for synthetic aperture radar imaging. In International conference on acoustics, speech, and signal processing. IEEE, 1873-1876.
[71] Yue Sun, Zhuoming Huang, Honggang Zhang, Zhi Cao, and Deqiang Xu. 2021. 3DRIMR: 3D reconstruction and imaging via mmWave radar based on deep learning. In 2021 IEEE International Performance, Computing, and Communications Conference (IPCCC). IEEE, 1-8.
[72] Yue Sun, Honggang Zhang, Zhuoming Huang, and Benyuan Liu. 2021. DeepPoint: A Deep Learning Model for 3D Reconstruction in Point Clouds via mmWave Radar. arXiv preprint arXiv:2109.09188 (2021).
[73] Masaki Takahashi, Takafumi Suzuki, Hideo Shitamoto, Toshiki Moriguchi, and Kazuo Yoshida. 2010. Developing a mobile robot for transport applications in the hospital domain. Robotics and Autonomous Systems 58, 7 (2010), 889-899.
[74]V. H. Tang, A. Bouzerdoum, S. L. Phung, and F. H. C. Tivive. 2016. Radar imaging of stationary indoor targets using joint low-rank and sparsity constraints. In 2016 IEEE International Conference on Acoustics, Speech and Signal Processing (ICASSP). 1412-1416. https://doi.org/10. 1109/ICASSP.2016.7471909
[75] Nico M Temme. 1996. Special functions: An introduction to the classical functions of mathematical physics. John Wiley & Sons.
[76] Roberto Vescovo. 1993. Array factor synthesis for circular antenna arrays. In Proceedings of IEEE Antennas and Propagation Society International Symposium. IEEE, 1574-1577.
[77] Ju Wang, Jie Xiong, Xiaojiang Chen, Hongbo Jiang, Rajesh Krishna Balan, and Dingyi Fang. 2017. TagScan: Simultaneous target imaging and material identification with commodity RFID devices. In Proceedings of the 23rd Annual International Conference on Mobile Computing and Networking. 288-300.
[78] Eric W. Weisstein. 2012. Bessel Function of the First Kind. From MathWorld-A Wolfram Web Resource. https://mathworld.wolfram. com/BesselFunctionoftheFirstKind.html
[79] Rob Weston, Sarah Cen, Paul Newman, and Ingmar Posner. 2019. Probably unknown: Deep inverse sensor modelling radar. In 2019 International Conference on Robotics and Automation (ICRA). IEEE, 5446-5452.
[80] Olive Emil Wetter. 2013. Imaging in airport security: Past, present, future, and the link to forensic and clinical radiology. Journal of Forensic Radiology and Imaging 1, 4 (2013), 152-160.
[81] Yaxiong Xie, Jie Xiong, Mo Li, and Kyle Jamieson. 2019. MD-Track: Leveraging Multi-Dimensionality for Passive Indoor Wi-Fi Tracking. In The 25th Annual International Conference on Mobile Computing and Networking (Los Cabos, Mexico) (MobiCom '19). Association for Computing Machinery, New York, NY, USA, Article 8, 16 pages. https://doi.org/10.1145/3300061.3300133
[82] Weiye Xu, Wenfan Song, Jianwei Liu, Yajie Liu, Xin Cui, Yuanqing Zheng, Jinsong Han, Xinhuai Wang, and Kui Ren. 2022. Mask does not matter: Anti-spoofing face authentication using mmWave without on-site registration. In Proceedings of the 28th Annual International Conference on Mobile Computing and Networking. 310-323.
[83] Hongfei Xue, Qiming Cao, Yan Ju, Haochen Hu, Haoyu Wang, Aidong Zhang, and Lu Su. 2023. M4esh: MmWave-Based 3D Human Mesh Construction for Multiple Subjects. In Proceedings of the 20th ACM Conference on Embedded Networked Sensor Systems (Boston, Massachusetts) (SenSys '22). Association for Computing Machinery, New York, NY, USA, 391-406. https://doi.org/10.1145/3560905.3568545
[84] Hongfei Xue, Yan Ju, Chenglin Miao, Yijiang Wang, Shiyang Wang, Aidong Zhang, and Lu Su. 2021. MmMesh: Towards 3D Real-Time Dynamic Human Mesh Construction Using Millimeter-Wave. In Proceedings of the 19th Annual International Conference on Mobile Systems, Applications, and Services (Virtual Event, Wisconsin) (MobiSys '21). Association for Computing Machinery, New York, NY, USA, 269-282. https://doi.org/i0.1145/3458864.3467679
[85] Muhammet Emin Yanik and Murat Torlak. 2019. Near-field MIMO-SAR millimeter-wave imaging with sparsely sampled aperture data. leee Access 7 (2019), 31801-31819.
[86] Muhammet Emin Yanik, Dan Wang, and Murat Torlak. 2020. Development and demonstration of MIMO-SAR mmWave imaging testbeds. IEEE Access 8 (2020), 126019-126038.
[87] Richard Zhang, Phillip Isola, Alexei A Efros, Eli Shechtman, and Oliver Wang. 2018. The Unreasonable Effectiveness of Deep Features as a Perceptual Metric. In CVPR.
[88] Mingmin Zhao, Tianhong Li, Mohammad Abu Alsheikh, Yonglong Tian, Hang Zhao, Antonio Torralba, and Dina Katabi. 2018. Throughwall human pose estimation using radio signals. In Proceedings of the IEEE Conference on Computer Vision and Pattern Recognition. 7356-7365.
[89] Mingmin Zhao, Yonglong Tian, Hang Zhao, Mohammad Abu Alsheikh, Tianhong Li, Rumen Hristov, Zachary Kabelac, Dina Katabi, and Antonio Torralba. 2018. RF-based 3D skeletons. In Proceedings of the 2018 Conference of the ACM Special Interest Group on Data Communication. 267-281.

What is claimed is:

1. A method for providing three-dimensional (3D) imaging using radio frequencies (RFs), the method comprising:
rotating a millimeter-wave (mmWave) radar chip comprising antennas on a mobile robot to emulate a cylindrical array of antennas;
receiving, by the rotating antennas, RF signals;
estimating locations of the rotating antennas when the RF signals were received;
processing the RF signals received by the antennas using the estimated locations of the antennas to provide 3D imaging; and
enhancing resolution of the 3D imaging using machine learning.

2. The method of claim 1 wherein enhancing resolution of the 3D imaging using machine learning comprises interpolating vertical imaging using the processed RF signals and machine learning.

3. The method of claim 2 wherein enhancing resolution of the 3D imaging using machine learning further comprises compressing RF signals along a range dimension using two-dimensional (2D) Convolutional Neural Networks (CNNs).

4. The method of claim 1 wherein estimating locations of the rotating antennas when the radio frequency signals were received comprises determining a motion of the robot.

5. The method of claim 4 wherein the locations of the antennas are estimated to a subwavelength location accuracy.

6. The method of claim 1 comprising recognizing objects in the 3D imaging.

7. The method of claim 1 wherein enhancing resolution of the 3D imaging comprises detecting transparent glass.

8. The method of claim 1 wherein the machine learning includes a model trained with RF data and LiDAR data of targets.

9. A system for providing three-dimensional (3D) imaging using radio frequencies (RFs), the system comprising:
a millimeter-wave (mmWave) radar chip on a mobile robot comprising antennas, the mmWave radar chip configured for rotating to emulate a cylindrical array of antennas; and
an RF imaging system configured for:
receiving, by the rotating antennas, RF signals;
estimating locations of the rotating antennas when the RF signals were received;
processing the RF signals received by the antennas using the estimated locations of the antennas to provide 3D imaging; and
enhancing resolution of the 3D imaging using machine learning.

10. The system of claim 9 wherein the RF imaging system is configured for interpolating vertical imaging using the processed RF signals and machine learning.

11. The system of claim 10 wherein the RF imaging system is configured for compressing RF signals along a range dimension using two-dimensional (2D) Convolutional Neural Networks (CNNs).

12. The system of claim 9 wherein the RF imaging system estimates locations of the rotating antennas when the radio frequency signals were received by determining a motion of the robot.

13. The system of claim 12 wherein the locations of the antennas are estimated to a subwavelength location accuracy.

14. The system of claim 9 wherein the RF imaging system is configured for recognizing objects in the 3D imaging.

15. The system of claim 9 wherein the RF imaging system is configured for detecting transparent glass.

16. The system of claim 9 wherein the machine learning includes a model trained with RF data and LiDAR data of targets.

17. A non-transitory computer readable medium having stored thereon executable instructions that when executed by at least one processor of at least one computer cause the at least one computer to perform steps comprising:
receiving, by rotating antennas of a millimeter-wave (mmWave) radar chip on a mobile robot, RF signals;
estimating locations of the rotating antennas when the RF signals were received;
processing the RF signals received by the antennas using the estimated locations of the antennas to provide 3D imaging; and
enhancing resolution of the 3D imaging using machine learning.

18. The non-transitory computer readable medium of claim 17 wherein enhancing resolution of the 3D imaging using machine learning comprises interpolating vertical imaging using the processed RF signals and machine learning.

19. The non-transitory computer readable medium of claim 18 wherein enhancing resolution of the 3D imaging using machine learning further comprises compressing RF signals along a range dimension using two-dimensional (2D) Convolutional Neural Networks (CNNs).

20. The non-transitory computer readable medium of claim 17 wherein estimating locations of the rotating antennas when the radio frequency signals were received comprises determining a motion of the robot.
